(19) United States
(12) Patent Application Publication
(10) Pub. No.: US 2014/0322437 A1
(43) Pub. Date: Oct. 30, 2014

(54) NON-MAGNETIC PARTICLES FOR NON-MAGNETIC UNDERCOAT LAYER OF MAGNETIC RECORDING MEDIUM, AND MAGNETIC RECORDING MEDIUM

(71) Applicant: TODA KOGYO CORPORATION, Otake-shi (JP)

(72) Inventors: Seiji ISHITANI, Otake-shi (JP); Hiroko MORII, Otake-shi (JP); Kazuyuki HAYASHI, Otake-shi (JP)

(21) Appl. No.: 14/329,003

(22) Filed: Jul. 11, 2014

Related U.S. Application Data
(62) Division of application No. 12/188,343, filed on Aug. 8, 2008.

(30) Foreign Application Priority Data
Aug. 10, 2007 (JP) 2007-209517

(51) Int. Cl. G11B 5/84

(52) U.S. Cl. CPC G11B 5/8404
USPC 427/131; 427/214

(57) ABSTRACT

The present invention relates to non-magnetic particles for non-magnetic undercoat layer of magnetic recording medium, comprising: hematite particles; an inner coating layer comprising a phosphorus-containing inorganic compound which is formed on a surface of the respective hematite particles; and an outer coating layer comprising an aluminum-containing inorganic compound which is formed on an outside of the inner coating layer comprising the phosphorus-containing inorganic compound.

This application is a divisional of application Ser. No. 12/188,343 filed Aug. 8, 2008, which in turn claims priority to Japanese Application No. 2007-209517, filed 10 Aug. 2007, the entire contents of each of which are hereby incorporated by reference.

### BACKGROUND OF THE INVENTION

The present invention relates to non-magnetic particles for non-magnetic undercoat layer of magnetic recording medium which are excellent in affinity to binder resins containing a metal sulfonate group and exhibit a less elution of iron ions therefrom, and a magnetic recording medium having a good surface smoothness (as a magnetic tape) and an excellent storage property.

Conventionally, it has been demanded to realize miniaturization and weight-reduction, long-time recording, high-density recording and increase in recording capacity of magnetic recording and reproducing apparatuses for audio or video equipments and computers. With such a demand, frequencies of carrier signals recorded in recent magnetic tapes tend to be shifted to a shorter wavelength region than those recorded in conventional magnetic tapes. As a result, the magnetization depth from the surface of the magnetic tape tends to become remarkably small, and the thickness of a magnetic recording layer of the magnetic tape tends to be reduced in order to improve high output characteristics, in particular, S/N ratio thereof.

However, when the thickness of the magnetic recording layer is reduced, there tends to arise problems such as difficulty in attaining a good surface smoothness of the magnetic recording layer and deterioration in strength of the resultant coating film. At present, it has been attempted to provide at least one undercoat layer comprising a binder resin and non-magnetic particles such as hematite particles dispersed in the binder resin (hereinafter referred to merely as a “non-magnetic undercoat layer”), on a non-magnetic substrate such as a base film in order to enhance a surface smoothness and a strength of the magnetic recording medium.

In recent years, it has been strongly demanded to realize further long-time recording of audio tapes or video tapes as well as further increase in recording capacity of magnetic tapes (back-up tapes) as external data-recording media owing to wide spread of personal computers and office computers. However, in the case of the audio tapes, video tapes and back-up tapes having a standardized size per one roll thereof, in order to achieve the long-time recording or increase in recording capacity, it is necessary to reduce a whole thickness of the tape and increase a length of the tape per a roll thereof. For this reason, it has been strongly required to reduce not only the thickness of the magnetic recording layer but also the thickness of each of the non-magnetic undercoat layer and the non-magnetic substrate. For example, in the conventional back-up tapes, the thickness of the non-magnetic undercoat layer which was past in the range of 3 to 5 μm has been recently reduced up to 1 to 3 μm.

In particular, when the thickness of the non-magnetic undercoat layer is reduced, the dispersing condition of the non-magnetic particles in the non-magnetic undercoat layer has a large influence on a surface smoothness of the magnetic recording medium. Specifically, when the thickness of the non-magnetic undercoat layer is reduced, undesirable protrusions tend to be formed on the surface of the non-magnetic undercoat layer even though the non-magnetic particles dispersed in the non-magnetic undercoat layer have such a particle size causing no significant problems in conventional magnetic tapes having a large thickness. As a result, the protrusions formed on the non-magnetic undercoat layer tend to adversely affect even the surface condition of the magnetic recording layer formed thereon, resulting in occurrence of drop-out.

Therefore, in order to realize magnetic recording media suitable for long-time recording and increase in recording capacity, it is inevitably required that the individual non-magnetic particles for non-magnetic undercoat layer are well dispersed in a coating material for the non-magnetic undercoat layer and, therefore, the surface of the non-magnetic undercoat layer formed is kept in a smooth condition. For the purpose of obtaining the coating material for non-magnetic undercoat layer having such an excellent dispersibility, it is required to enhance an affinity of the non-magnetic particles for non-magnetic undercoat layer to the binder resin.

In order to enhance the affinity between the binder resin and the non-magnetic particles for non-magnetic undercoat layer, there are generally used those binder resins such as polyurethane resins and vinyl chloride-vinyl acetate copolymers, into which a polar group such as a metal sulfonate group and a COOH group is introduced. Consequently, in order to more efficiently enhance the affinity between the binder resin and the non-magnetic particles for non-magnetic undercoat layer, it is demanded to provide the non-magnetic particles capable of allowing the polar group of the binder resin to exhibit a good adsorptivity thereto and firmly bond thereto.

In addition, with the progress of high-density recording, the magnetic recording medium has been required to have a good reliability of recording as well as an enhanced storage property capable of preserving the tape for a long period of time. In the magnetic recording medium of a coating type, in order to ensure a good travelling property (reduce a friction coefficient thereof), it is known to incorporate a lubricant such as fatty acids thereinto. For this reason, if the tape is exposed to high-temperature and high-humidity environmental conditions for a long period of time, water-soluble salt components such as metal salts which are present in inorganic particles contained in the magnetic layer, non-magnetic layer and/or back coat layer, are reacted with the above fatty acids to form fatty acid compounds (for example, fatty acid sodium salts, etc.), so that protrusions are formed on the surface of the coating film, and output characteristics or electromagnetic conversion property (signal recording property) such as C/N ratio tend to be adversely affected. Further, in the worse case, the tape tends to suffer from sticking phenomenon owing to increase in friction coefficient thereof, resulting in problems such as interrupted travelling of the tape. In addition, a spacing loss of a magnetic head tends be induced owing clogging of a head gap, so that it may be difficult to carry out reproduction of magnetically recorded information.

In particular, as the non-magnetic particles for non-magnetic undercoat layer, hematite particles are usually used. The hematite particles forming the non-magnetic undercoat layer tend to be eluted out in the form of iron ions into an upper layer of the tape when exposed to high-temperature and high-humidity conditions, so that the eluted iron ions tend to be reacted to the fatty acids to form the fatty acid compounds, resulting in formation of protrusions on the surface of the tape, increase in friction coefficient and, therefore, disturbed travelling of the tape.

Accordingly, it has been demanded to provide hematite particles for non-magnetic undercoat layer which exhibit a less elution of iron ions therefrom even when exposed to high-temperature and high-humidity conditions.

There have been proposed the method for enhancing a surface smoothness and a storage property of a magnetic tape by treating the surface of iron oxide particles with a phosphorus compound and then washing the thus surface-treated iron oxide particles with water to remove P physically adsorbed on the particles therefrom and suppress elution of iron (International Patent Application Laid-Open No. 2005-004116), and the method for enhancing a storage property of a magnetic recording medium by incorporating iron oxide particles which are surface-treated with an oxide and/or a hydroxide of Al and Zn, into a non-magnetic undercoat layer (Japanese Patent Application Laid-Open (KOKAI) No. 2001-160211).

At present, it has been strongly required to provide non-magnetic particles for non-magnetic undercoat layer of magnetic recording medium which are capable of producing such a magnetic recording medium having a good surface smoothness as a tape and an excellent storage property. However, such non-magnetic particles cannot be obtained until now.

That is, in the method described in International Patent Application Laid-Open No. 2005-004116, although iron oxide hydroxide particles are surface-treated with an Al compound as shown in the below-mentioned Comparative Examples 2-3, since the thus treated iron oxide hydroxide particles are then heat-treated to form hematite particles, diffusion of iron into the Al surface coating layer or diffusion of Al into the hematite particles tends to occur, so that the hematite particle layer tends to be exposed onto the Al surface coating layer. As a result, it may be difficult to suppress elution of iron ions therefrom, resulting in deteriorated storage property of the magnetic recording medium.

Also, in the method described in Japanese Patent Application Laid-Open (KOKAI) No. 2001-160211, although the iron oxide particles are surface-treated with an oxide and/or a hydroxide of Al and Zn, as shown in the below-mentioned Comparative Examples 2-6, the amount of sodium dodecylbenzenesulfonate containing a metal sulfonate group which is adsorbed onto the particles is small, so that an affinity of the particles to the resin containing a metal sulfonate group tends to be deteriorated, resulting in poor surface smoothness of a magnetic tape when the thickness of the tape is reduced.

### SUMMARY OF THE INVENTION

An object of the present invention is to provide non-magnetic particles for non-magnetic undercoat layer of magnetic recording medium which are capable of producing a magnetic recording medium having a good surface smoothness as a tape even when the thickness of the non-magnetic undercoat layer is reduced, and an excellent storage property, and exhibit an excellent affinity to binder resins containing a metal sulfonate group and are prevented from undergoing elution of iron ions therefrom.

The above object can be achieved by the following aspects of the present invention.

That is, to accomplish the aim, in a first aspect of the present invention, there are provided non-magnetic particles for non-magnetic undercoat layer of magnetic recording medium, comprising:

hematite particles;

an inner coating layer comprising a phosphorus-containing inorganic compound which is formed on a surface of the respective hematite particles; and

an outer coating layer comprising an aluminum-containing inorganic compound which is formed on an outside of the inner coating layer comprising the phosphorus-containing inorganic compound (Invention 1).

In a second aspect of the present invention, there are provided the non-magnetic particles for non-magnetic undercoat layer of magnetic recording medium according to the Invention 1, wherein a content of P in the inner coating layer comprising the phosphorus-containing inorganic compound is 0.1 to 5% by weight, and a content of Al in the outer coating layer comprising the aluminum-containing inorganic compound is 0.1 to 8% by weight (Invention 2).

In a third aspect of the present invention, there are provided non-magnetic particles for non-magnetic undercoat layer of magnetic recording medium according to the Invention 1 or 2, further comprising a compound containing at least one rare earth element, in an amount of 0.1 to 20% by weight in terms of the rare earth element (Invention 3).

In a fourth aspect of the present invention, there are provided composite non-magnetic particles for non-magnetic undercoat layer of magnetic recording medium, comprising the non-magnetic particles for non-magnetic undercoat layer as defined in the Invention 1, a coating layer comprising a surface-modifying agent which is formed on a surface of the respective non-magnetic particles, and carbon black adhered onto the coating layer (Invention 4).

In a fifth aspect of the present invention, there is provided a magnetic recording medium comprising a non-magnetic substrate; a non-magnetic undercoat layer formed on the non-magnetic substrate which comprises the non-magnetic particles for non-magnetic undercoat layer of magnetic recording medium as defined in the Invention 1 or the composite non-magnetic particles for non-magnetic undercoat layer of magnetic recording medium as defined in the Invention 4, and a binder resin; and a magnetic recording layer formed on the non-magnetic undercoat layer which comprises magnetic particles and a binder resin (Invention 5).

In a sixth aspect of the present invention, there is provided a magnetic recording medium comprising a non-magnetic substrate; a non-magnetic undercoat layer formed on one surface of the non-magnetic substrate which comprises the non-magnetic particles for non-magnetic undercoat layer of magnetic recording medium as defined in the Invention 1 or the composite non-magnetic particles for non-magnetic undercoat layer of magnetic recording medium as defined in the Invention 4, and a binder resin; a magnetic recording layer formed on the non-magnetic undercoat layer which comprises magnetic particles and a binder resin; and a back coat layer formed on the opposite surface of the non-magnetic substrate.

### DETAILED DESCRIPTION OF THE INVENTION

The present invention will be described in detail below.

First, the non-magnetic particles for non-magnetic undercoat layer of magnetic recording medium according to the present invention are described.

The non-magnetic particles for non-magnetic undercoat layer of magnetic recording medium according to the present invention comprise hematite particles, an inner coating layer formed on the surface of the respective hematite particles which comprises a phosphorus-containing inorganic compound, and an outer coating layer formed on the inner coating layer which comprises an aluminum-containing inorganic compound.

The non-magnetic particles for non-magnetic undercoat layer according to the present invention may be of any shape including an acicular shape, a spindle shape, a rice grain-like shape, a spherical shape, a granular shape, a polyhedral shape, a flake-like shape, a scale-like shape and a plate shape, etc.

The non-magnetic particles for non-magnetic undercoat layer according to the present invention have an average primary major axis diameter of 0.005 to 0.30 w, preferably 0.010 to 0.25 μm and more preferably 0.015 to 0.20 μm.

When the average primary major axis diameter of the non-magnetic particles for non-magnetic undercoat layer according to the present invention is more than 0.30 μm, the non-magnetic undercoat layer formed by using such particles tends to be deteriorated in surface smoothness. When the average primary major axis diameter of the non-magnetic particles for non-magnetic undercoat layer according to the present invention is less than 0.005 μm, the particles tend to be agglomerated together by increase in intermolecular force therebetween owing to fineness thereof, resulting in poor dispersion of the particles in a vehicle.

The non-magnetic particles for non-magnetic undercoat layer according to the present invention preferably have an aspect ratio (ratio of average primary major axis diameter to average primary minor axis diameter; hereinafter referred to merely as the “aspect ratio”) of 2.0 to 20.0, more preferably 2.5 to 18.0 and still more preferably 3.0 to 15.0.

The non-magnetic particles for non-magnetic undercoat layer according to the present invention preferably have a BET specific surface area of 10 to 200 m²/g, more preferably 15 to 180 m²/g and still more preferably 20 to 160 m²/g. When the BET specific surface area of the non-magnetic particles is less than 10 m²/g, the magnetic recording medium formed by using the particles tends to be deteriorated in surface smoothness of the coating film. When the BET specific surface area of the non-magnetic particles is more than 200 m²/g, the particles tend to be agglomerated together by increase in intermolecular force therebetween owing to fineness thereof, resulting in poor dispersion of the particles in a vehicle.

In the non-magnetic particles for non-magnetic undercoat layer according to the present invention, the content of P in the inner coating layer formed on the surface of the respective hematite particles which comprises a phosphorus-containing inorganic compound is preferably 0.1 to 5.0% by weight, and the content of Al in the outer coating layer formed on the inner coating layer which comprises an aluminum-containing inorganic compound is preferably 0.1 to 8.0% by weight. When the P content and the Al content in the respective coating layers are less than 0.1% by weight, the surface of the respective hematite particles may fail to be sufficiently covered with the phosphorus-containing inorganic compound or the aluminum-containing inorganic compound, resulting in increased amount of iron ions eluted from the non-magnetic particles for non-magnetic undercoat layer. As a result, when the non-magnetic undercoat layer is formed by using the particles, the resultant magnetic recording tape tends to be deteriorated in storage property. On the other hand, when the P content in the inner coating layer is more than 5.0% by weight or the Al content in the outer coating layer is more than 8.0% by weight, since the effect of reducing the amount of iron ions eluted from the non-magnetic particles for non-magnetic undercoat layer is already saturated, the coating with such a large amount of the respective compounds is unnecessary. More preferably, in the non-magnetic particles for non-magnetic undercoat layer, the P content in the inner coating layer formed on the respective hematite particles which comprises a phosphorus-containing inorganic compound is 0.3 to 4.0% by weight, and the Al content in the outer coating layer formed on the inner coating layer which comprises an aluminum-containing inorganic compound is 0.2 to 7.0% by weight.

In the non-magnetic particles for non-magnetic undercoat layer according to the present invention, the ratio of the Al content in the outer coating layer formed on the inner coating layer which comprises an aluminum-containing inorganic compound to the P content in the inner coating layer formed on the respective hematite particles which comprises a phosphorus-containing compound is preferably 0.30 to 2.00. When the Al/P content ratio lies within the above-specified range, it is possible to reduce the amount of iron ions eluted from the non-magnetic particles for non-magnetic undercoat layer, and enhance the amount of sodium dodecylbenzenesulfonate adsorbed therein. The Al/P content ratio in these coating layers is more preferably 0.35 to 1.95.

The non-magnetic particles for non-magnetic undercoat layer according to the present invention may also contain a rare earth element such as Y and Nd in an amount of 0.1 to 20% by weight.

The amount of sodium dodecylbenzenesulfonate adsorbed into the non-magnetic particles for non-magnetic undercoat layer according to the present invention is preferably not less than 1.00 mg/m², more preferably not less than 1.03 mg/m² and still more preferably not less than 1.05 mg/m². When the amount of sodium dodecylbenzenesulfonate adsorbed into the particles is less than 1.00 mg/m², the non-magnetic particles tend to be deteriorated in affinity to binder resins containing a sodium sulfonate group, so that a tape including the non-magnetic undercoat layer having a reduced thickness tends to be deteriorated in surface smoothness. The upper limit of the amount of sodium dodecylbenzenesulfonate adsorbed into the non-magnetic particles is about 2.00 mg/m².

The amount of iron ions eluted from the non-magnetic particles for non-magnetic undercoat layer according to the present invention is preferably not more than 5.0 ppm, more preferably not more than 4.5 ppm and still more preferably not more than 4.0 ppm in terms of Fe. When the tape obtained by using the non-magnetic particles exhibiting an iron ion elution of more than 5.0 ppm is preserved under high-temperature and high-humidity conditions, since a large amount of iron ions are eluted from the hematite particles, there tends to arise such a problem that the iron ions eluted are reacted with fatty acids to form fatty acid iron salts, resulting in formation of precipitates on the surface of the tape. Further, the precipitated fatty acid iron salts tend to be transferred to a magnetic layer of the tape, resulting in problems such as increase in drop-out. The lower limit of the amount of iron ions eluted from the non-magnetic particles is 1.0 ppm.

The surface of the respective non-magnetic particles for non-magnetic undercoat layer according to the present invention may be further adhered with carbon black through a surface-modifying agent to form composite non-magnetic particles for non-magnetic undercoat layer, thereby further suppressing elution of iron ions therefrom.

The surface-modifying agent used in the present invention is not particularly limited as long as it allows carbon black to adhere onto the surface of the respective non-magnetic particles for non-magnetic undercoat layer. Examples of the surface-modifying agent suitable used in the present invention include organosilicon compounds such as alkoxysilanes, fluoroalkylsilanes and organopolysiloxanes, and low-molecular weight or high-molecular weight surfactants.

Specific examples of the organosilicon compounds include alkoxysilanes such as methyl triethoxysilane, dimethyl diethoxysilane, phenyl triethoxysilane, diphenyl diethoxysilane, methyl trimethoxysilane, dimethyl dimethoxysilane, phenyl trimethoxysilane, diphenyl dimethoxysilane, ethyl triethoxysilane, propyl triethoxysilane, butyl triethoxysilane, isobutyl trimethoxysilane, hexyl triethoxysilane, octyl triethoxysilane and decyl triethoxysilane; fluoroalkylsilanes such as trifluoropropyl trimethoxysilane, tridecafluorooctyl trimethoxysilane, heptadecafluorodecyl trimethoxysilane, trifluoropropyl triethoxysilane, heptadecafluorodecyl triethoxysilane and tridecafluorooctyl triethoxysilane; and organopolysiloxanes such as polysiloxane, methyl hydrogen polysiloxane and modified polysiloxanes.

Examples of the low-molecular weight surfactants include alkylbenzenesulfonates, dioctylsulfosuccinates, alkylamineacetates and alkyl fatty acid salts. Examples of the high-molecular weight surfactants include polyvinyl alcohol, polyacrylic acid salts, carboxymethyl cellulose, acrylic acid-maleate copolymers and olefin-maleate copolymers.

In view of the effect of adhering carbon black onto the non-magnetic particles, among these surface-modifying agents, preferred are the organosilicon compounds such as alkoxysilanes and polysiloxanes.

The coating amount of the surface-modifying agent is preferably 0.05 to 15.0% by weight, more preferably 0.10 to 12.0% by weight and still more preferably 0.10 to 10.0% by weight in terms of C on the basis of the weight of the non-magnetic particles for non-magnetic undercoat layer which are coated with the surface-modifying agent.

Examples of the carbon black used in the present invention include commercially available furnace blacks, channel blacks, acetylene blacks and graphitized carbon blacks. Specific examples of the commercially available furnace blacks, channel blacks, acetylene blacks or the like include “#3050”, “MA100”, “MA7”, “#1000”, “#2400B”, “#30”, “MA77”, “MA8”, “#650”, “MA11”, “#50”, “#52”, “#45”, etc., (tradenames; all produced by Mitsubishi Chemical Corp.); “SHEAST 9H”, “SHEAST 7H”, “SHEAST 6”, “SHEAST 3H”, “SHEAST 300”, “SHEAST FM”, etc., (tradenames; all produced by Tokai Carbon Co., Ltd.); “Raven 1250”, “Raven 860 ULTRA”, “Raven 1000” and “Raven 1190 ULTRA” (tradenames; all produced by Colombian Chemicals Co.); “Koechen Black EC” and “Koechen Black EC600JD” (tradenames; all produced by Koechen Black International Corp.); and “BLACK PEARLS-L”, “BLACK PEARLS 1000”, “BLACK PEARLS 4630”, “VULCAN XC72”, “ELFTEX 410”, “REGAL 660” and “REGAL 400” (tradenames; all produced by Cabot Specialty Chemicals Inc.).

The carbon black may be previously subjected to disaggregation treatment and then washed with water to obtain a high-purity carbon black. Further, after adding an aqueous alkali solution to a water suspension containing the previously disaggregated carbon black to control a pH value thereof to not less than 13, the resultant mixture may be heat-treated at a temperature of 80 to 103° C. and then washed with water to obtain a still higher-purity carbon black. When being surface-treated with the thus prepared high-purity carbon black, it is possible to obtain the non-magnetic particles for non-magnetic undercoat layer which contain a less amount of soluble metal salts.

The carbon black used in the present invention is adhered onto a coating layer of the surface-modifying agent which is formed on the surface of the respective non-magnetic particles for non-magnetic undercoat layer. If required, the carbon black-adhesion layer may also be coated with the surface-modifying agent, and additional carbon black may be further adhered onto the resultant coating layer of the surface-modifying agent to form two carbon black layers on the respective non-magnetic particles. In addition, by repeating the above procedure, three or more carbon black layers may be formed on the non-magnetic particles.

The amount of carbon black adhered per one carbon black layer in the present invention is preferably 1 to 25 parts by weight and more preferably 1 to 20 parts by weight on the basis of 100 parts by weight of the non-magnetic particles for non-magnetic undercoat layer. Also, the total amount of carbon black adhered is preferably 1 to 50 parts by weight, more preferably 5 to 45 parts by weight and still more preferably 10 to 40 parts by weight on the basis of 100 parts by weight of the non-magnetic particles for non-magnetic undercoat layer.

When the amount of carbon black adhered per one carbon black layer is more than 25 parts by weight on the basis of 100 parts by weight of the non-magnetic particles for non-magnetic undercoat layer, the percentage of desorption of carbon black from the non-magnetic particles tends to be increased, so that the desorbed carbon black tends to inhibit the non-magnetic particles from being uniformly dispersed in a vehicle upon production of a non-magnetic coating material. As a result, it may be difficult to obtain a magnetic recording medium having a smooth surface.

When the total amount of carbon black adhered is less than 1 part by weight on the basis of 100 parts by weight of the non-magnetic particles for non-magnetic undercoat layer, it may be difficult to sufficiently reduce the amount of iron ions eluted from the obtained composite non-magnetic particles for non-magnetic undercoat layer owing to an insufficient amount of carbon black adhered thereon. When the total amount of carbon black adhered is more than 50 parts by weight, even though a plurality of carbon layers are formed, the percentage of desorption of carbon black from the particles tends to be increased, so that the desorbed carbon black tends to inhibit the non-magnetic particles from being uniformly dispersed in a vehicle upon production of a non-magnetic coating material. As a result, it may be difficult to obtain a magnetic recording medium having a smooth surface.

In the present invention, the above surface-modifying agent may be used between the carbon black layers. For the purpose of firmly and uniformly bonding the carbon black layers to each other, the organosilicon compounds are preferably used as the surface-modifying agent.

The particle shape of the composite non-magnetic particles for non-magnetic undercoat layer according to the Invention 4 largely varies depending upon the particle shape of the above non-magnetic particles for non-magnetic undercoat layer, and has a similar particle configuration to that of the above non-magnetic particles for non-magnetic undercoat layer.

The composite non-magnetic particles for non-magnetic undercoat layer according to the Invention 4 have an average primary major axis diameter of 0.005 to 0.30 μm, preferably 0.010 to 0.25 μm and more preferably 0.015 to 0.20 μm.

The composite non-magnetic particles for non-magnetic undercoat layer according to the Invention 4 preferably have a BET specific surface area of 10 to 200 m²/g, more preferably 15 to 180 m²/g and still more preferably 20 to 160 m²/g.

The amount of sodium dodecylbenzenesulfonate adsorbed into the composite non-magnetic particles for non-magnetic undercoat layer according to the Invention 4 is preferably not less than 1.00 mg/m². The upper limit of the amount of sodium dodecylbenzenesulfonate adsorbed into the composite non-magnetic particles is about 2.00 mg/m².

The amount of iron ions eluted from the composite non-magnetic particles for non-magnetic undercoat layer according to the Invention 4 is preferably not more than 4 ppm in terms of Fe. The lower limit of the amount of iron ions eluted from the composite non-magnetic particles is 1 ppm.

Next, the process for producing the non-magnetic particles for non-magnetic undercoat layer of magnetic recording medium according to the present invention is described.

The non-magnetic particles for non-magnetic undercoat layer according to the present invention can be produced by coating the surface of the respective hematite particles to be treated, with a phosphorus-containing inorganic compound and further coating the surface of the resultant coating layer comprising the phosphorus-containing inorganic compound with an aluminum-containing inorganic compound.

The hematite particles as the particles to be treated in the present invention can be produced by heat-dehydrating the goethite particles as a starting material in a temperature range of 250 to 850° C.

The ordinary method for producing the goethite particles as a precursor of the hematite particles used in the present invention is described below.

As described hereinafter, the goethite particles can be produced by passing an oxygen-containing gas such as air through a suspension containing ferrous precipitates such as hydroxides of iron or iron carbonate which are obtained by reacting a ferrous salt with either alkali hydroxide, alkali carbonate or mixed alkali comprising alkali hydroxide and alkali carbonate.

As known in the art, as typical basic reactions for production of goethite particles, there are exemplified (1) a method of subjecting a suspension having a pH value of not less than 11 and containing colloidal ferrous hydroxide particles which is obtained by adding not less than an equivalent of an aqueous alkali hydroxide solution to an aqueous ferrous salt solution, to oxidation reaction by passing an oxygen-containing gas therethrough at a temperature of not higher than 80° C., thereby producing acicular goethite particles; (2) a method of subjecting a suspension containing FeCO₃ which is obtained by reacting an aqueous ferrous salt solution with an aqueous alkali carbonate solution, to oxidation reaction by passing an oxygen-containing gas therethrough, if required, after aging the suspension, thereby producing spindle-shaped goethite particles; (3) a method of subjecting a suspension containing iron-containing precipitates which is obtained by reacting an aqueous ferrous salt solution with an aqueous alkali carbonate solution and an alkali hydroxide, to oxidation reaction by passing an oxygen-containing gas therethrough, if required, after aging the suspension, thereby producing spindle-shaped goethite particles; (4) a method of subjecting an aqueous ferrous salt solution containing colloidal ferrous hydroxide particles which is obtained by adding less than an equivalent of an aqueous alkali hydroxide solution or an aqueous alkali carbonate solution to an aqueous ferrous salt solution, to oxidation reaction by passing an oxygen-containing gas therethrough, thereby producing acicular goethite seed particles; adding to the thus obtained aqueous ferrous salt solution containing the acicular goethite seed particles, not less than an equivalent of an aqueous alkali hydroxide solution based on Fe₂₊ contained in the aqueous ferrous salt solution; and then passing an oxygen-containing gas through the resultant mixed aqueous solution, thereby growing the above acicular goethite seed particles; (5) a method of subjecting an aqueous ferrous salt solution containing colloidal ferrous hydroxide particles which is obtained by adding less than an equivalent of an aqueous alkali hydroxide solution or an aqueous alkali carbonate solution to an aqueous ferrous salt solution, to oxidation reaction by passing an oxygen-containing gas therethrough, thereby producing acicular goethite seed particles; adding to the thus obtained aqueous ferrous salt solution containing the acicular goethite seed particles, not less than an equivalent of an aqueous alkali carbonate solution based on Fe₂₊ contained in the aqueous ferrous salt solution; and then passing an oxygen-containing gas through the resultant mixed aqueous solution, thereby growing the above acicular goethite seed particles; and (6) a method of subjecting an aqueous ferrous salt solution containing colloidal ferrous hydroxide particles which is obtained by adding less than an equivalent of an alkali hydroxide or an aqueous alkali carbonate solution to an aqueous ferrous salt solution, to oxidation reaction by passing an oxygen-containing gas therethrough, thereby producing acicular goethite seed particles; and then growing the obtained acicular goethite seed particles in an acidic or neutral range.

Meanwhile, different kinds of elements such as Al, Zr, Ti, P, Si, Sn, Sb, Y, Nb and Mn may be added during the production reaction of the goethite particles in order to improve various properties of the particles such as major axial diameter, minor axial diameter and aspect ratio thereof. In particular, in view of enhancing a strength of a coating film provided in the resultant magnetic recording medium, aluminum is preferably incorporated into the particles. The total amount of the different kinds of elements incorporated into the particles is preferably 0.05 to 50% by weight, more preferably 0.10 to 40% by weight and still more preferably 0.15 to 30% by weight in terms of the respective elements.

The particle shape of the goethite particles used in the present invention may be of any shape including an acicular shape, a spindle shape, a rice grain-like shape, a spherical shape, a granular shape, a polyhedral shape, a flake-like shape, a scale-like shape and a plate shape, etc. In view of a suitable aspect ratio of the hematite particles produced from the above goethite particles, among these particle shapes, preferred are the acicular shape, spindle shape and rice grain-like shape having an aspect ratio (average primary major axis diameter/average primary minor axis diameter) of 2.0 to 20.0, more preferably 2.5 to 18.0 and still more preferably 3.0 to 15.0.

The goethite particles used in the present invention have an average primary major axis diameter of 0.005 to 0.40 μm and a BET specific surface area of 20 to 250 m²/g.

The surface of the respective goethite particles used in the present invention may be coated with one or more rare earth elements such as Y and Nd, whereby when calcining the goethite particles into the hematite particles at a high temperature, occurrence of sintering between the particles can be suppressed, thereby enhancing a surface smoothness of a coating film obtained by using the particles. The coating amount of the rare earth compound such as hydroxides of rare earth elements is preferably 0.1 to 20% by weight in terms of a sum of the rare earth elements on the basis of the weight of the goethite particles.

When subjecting the goethite particles to heat dehydration, the surface of the respective goethite particles is preferably previously coated with an anti-sintering agent. The coating treatment with the anti-sintering agent may be carried out as follows. That is, after the anti-sintering agent is added to a water suspension containing the goethite particles as starting material particles, the obtained mixture is uniformly mixed and stirred, and then the pH value of the mixture is controlled such that the anti-sintering agent is suitably coated onto the surface of the respective goethite particles, followed by subjecting the resultant particles to filtration, washing with water and drying.

As the anti-sintering agent, there may be used one or more compounds ordinarily used for this purpose, selected from phosphorus compounds such as sodium hexametaphosphate, polyphosphoric acid and orthophosphoric acid; silicon compounds such as water glass #3, sodium orthosilicate, sodium metasilicate and colloidal silica; boron compounds such as boric acid; aluminum salts such as aluminum acetate, aluminum sulfate, aluminum chloride and aluminum nitrate; alkali aluminates such as sodium aluminate; aluminum compounds such as alumina sol and aluminum hydroxide; and titanium compounds such as titanium oxysulfate. In particular, in view of preventing occurrence of sintering between the particles upon the calcination at a high temperature, one or more compounds containing rare earth elements such as yttrium and neodymium are preferably used as the anti-sintering agent.

The amount of the anti-sintering agent present on the surface of the respective goethite particles varies depending upon various conditions such as kind and amount of the anti-sintering agent used, pH value of the aqueous alkali solution and heat-treating temperature, and is usually 0.05 to 20% by weight on the basis of the total weight of the goethite particles.

The hematite particles used in the present invention are preferably high-density hematite particles obtained by subjecting the goethite particles as a starting material to low-temperature heat dehydration in a temperature range of 250 to 500° C. to thereby obtain low-density hematite particles, and then heat-treating the thus obtained low-density hematite particles in a high temperature range of 500 to 850° C.

When the temperature used upon the low-temperature heat dehydration is less than 250° C., the dehydration reaction tends to be undesirably prolonged. When the temperature used upon the low-temperature heat dehydration is more than 500° C., the dehydration reaction tends to proceed too rapidly, resulting in breakage of the particle shape or occurrence of sintering between the particles. The low-density hematite particles obtained by the low-temperature heat dehydration treatment comprise such low-density particles having a large number of dehydration pores formed by removal of H₂O from the goethite particles, and the a BET specific surface area thereof is about 1.2 to about 2 times that of the goethite particles as a starting material.

Also, when the low-density hematite particles are heat-treated at a high temperature of 500 to 850° C. to obtain high-density acicular hematite particles, if the heat-treating temperature is less than 500° C., the densification of the particles tends to be insufficient, so that a large number of dehydration pores tend to still remain within and on the surface of the hematite particles. As a result, it may be difficult to disperse the obtained particles in a vehicle. Further, when the non-magnetic undercoat layer is formed by using the particles, it may be difficult to obtain a coating film having a smooth surface. On the other hand, if the heat-treating temperature exceeds 850° C., although the high densification of the hematite particles is made to a sufficient extent, sintering tends to be caused on and between the particles, resulting in increased particle size. As a result, it may be difficult to obtain a coating film having a smooth surface.

The hematite particles used in the present invention may also contain one or more rare earth elements such as Y and Nd in an amount of 0.1 to 20% by weight.

When coating the surface of the respective hematite particles with the rare earth elements, it is possible to reduce the amount of iron ions eluted from the surface of the respective hematite particles, and enhance a storage property of a tape formed by using the particles.

The particle shape of the hematite particles used in the present invention may be of any shape including an acicular shape, a spindle shape, a rice grain-like shape, a spherical shape, a granular shape, a polyhedral shape, a flake-like shape, a scale-like shape and a plate shape, etc. In view of a strength of a coating film in the resultant magnetic recording medium, among these particle shapes, preferred are the acicular shape, spindle shape and rice grain-like shape having an aspect ratio (average primary major axis diameter/average primary minor axis diameter) of 2.0 to 20.0, more preferably 2.5 to 18.0 and still more preferably 3.0 to 15.0.

The hematite particles used in the present invention have an average primary major axis diameter of 0.005 to 0.30 μm, preferably 0.010 to 0.25 μm and more preferably 0.015 to 0.20 μm.

When the average primary major axis diameter of the hematite particles is more than 0.30 μm, the resultant non-magnetic particles for non-magnetic undercoat layer obtained by using the hematite particles also tend to be coarse particles, so that the non-magnetic undercoat layer formed by using the non-magnetic particles tends to be deteriorated in surface smoothness on the coating film. When the average primary major axis diameter of the hematite particles is less than 0.005 μm, the obtained particles tend to be agglomerated together by increased intermolecular force therebetween owing to fineness thereof, so that it may be difficult to conduct a uniform coating treatment of the surface of the respective hematite particles with the phosphorus-containing inorganic compound and further a uniform coating treatment of the surface of the thus formed coating layer with the aluminum-containing inorganic compound.

The hematite particles used in the present invention preferably have a BET specific surface area of 10 to 200 m²/g, more preferably 15 to 180 m²/g and still more preferably 20 to 160 m²/g. When the BET specific surface area of the hematite particles is less than 10 m²/g, the hematite particles tend to be coarse, or sintering between the particles tends to be caused, so that the resultant non-magnetic particles for non-magnetic undercoat layer obtained by using the hematite particles also tend to be coarse particles. As a result, the magnetic recording medium obtained by using the non-magnetic particles tends to be deteriorated in surface smoothness on the coating film. When the BET specific surface area of the hematite particles is more than 200 m²/g, the obtained particles tend to be agglomerated together by increased intermolecular force therebetween owing to fineness thereof, so that it may be difficult to conduct a uniform coating treatment of the surface of the respective hematite particles with the phosphorus-containing inorganic compound and further a uniform coating treatment of the surface of the thus formed coating layer with the aluminum-containing inorganic compound.

The amount of sodium dodecylbenzenesulfonate adsorbed onto the hematite particles used in the present invention is less than 1 mg/m².

The amount of iron ions eluted from the hematite particles used in the present invention is not less than 20 ppm.

When the surface of the respective hematite particles used in the present invention is coated with one or more rare earth elements such as Y and Nd, the amount of iron ions eluted from the surface of the respective hematite particles can be reduced, so that the tape obtained by using the hematite particles can be further enhanced in storage property. The coating amount of hydroxides of rare earth elements, etc., on the surface of the respective hematite particles is preferably 0.1 to 20% by weight in terms of a sum of the rare earth elements on the basis of the weight of the non-magnetic particles for non-magnetic undercoat layer.

Next, the method of coating the hematite particles as the particles to be treated according to the present invention with the phosphorus-containing inorganic compound and further coating the surface of the resultant coating layer with the aluminum-containing inorganic compound is described.

The non-magnetic particles for non-magnetic undercoat layer according to the present invention can be produced by adding a phosphorus compound to a water suspension of the hematite particles to be treated, mixing the obtained suspension under stirring, and adjusting the pH value of the suspension using an acid or an alkali to coat the surface of the respective hematite particles with the phosphorus-containing inorganic compound, followed by subjecting the resultant particles to filtration, washing with water and drying; and further by adding an aluminum compound to a water suspension of the thus obtained hematite particles whose surface is coated with the phosphorus-containing inorganic compound, mixing the resultant suspension under stirring, and adjusting the pH value of the suspension using an acid or an alkali to coat the surface of the coating layer comprising the phosphorus-containing inorganic compound formed on the surface of the respective hematite particles, with the aluminum-containing inorganic compound, followed by subjecting the resultant particles to filtration, washing with water and drying.

As the phosphorus compound, there may be used phosphorus compounds such as sodium hexametaphosphate, polyphosphoric acid and orthophosphoric acid.

The amount of the phosphorus compound added is preferably controlled such that the content of P in the coating layer comprising the phosphorus-containing inorganic compound which is formed on the surface of the respective hematite particles is 0.1 to 5% by weight in terms of P.

As the aluminum compound, there may be used aluminum salts such as aluminum acetate, aluminum sulfate, aluminum chloride and aluminum nitrate; alkali aluminates such as sodium aluminate; and aluminum compounds such as alumina sol and aluminum hydroxide.

The amount of the aluminum compound added is preferably controlled such that the content of Al in the coating layer comprising the aluminum-containing inorganic compound which is formed on the surface of the respective hematite particles is 0.1 to 8% by weight in terms of Al.

Next, the process for producing the composite non-magnetic particles for non-magnetic undercoat layer according to the Invention 4 is described.

The composite non-magnetic particles for non-magnetic undercoat layer according to the Invention 4 can be produced by mixing the non-magnetic particles for non-magnetic undercoat layer according to the present invention with a surface-modifying agent to coat the surface of the respective non-magnetic particles for non-magnetic undercoat layer with the surface-modifying agent, and then mixing the non-magnetic particles for non-magnetic undercoat layer which are coated with the surface-modifying agent, with carbon black.

As the carbon black, in view of a good storage property of the resultant tape, highly-purified carbon black is preferably used. The highly-purified carbon black may be produced by previously disaggregating carbon black and then dispersing the disaggregated carbon black in water to subject the carbon black to water-washing treatment.

The disaggregation treatment of the carbon black may be conducted by any suitable method as long as agglomerates of the carbon black can be well disaggregated thereby. In particular, in the disaggregation treatment, there is preferably used those apparatus capable of applying a shear force to the particles, more preferably those apparatuses capable of conducting application of shear force, spatula-stroking and compression at the same time. As such apparatuses, there may be used wheel-type kneaders, ball-type kneaders, blade-type kneaders, roll-type kneaders or the like.

As the water used upon the water-washing treatment of the carbon black, there may be suitably used pure water, deionized ion-exchanged water, distilled water or the like. Also, the hydrophobic carbon black can be efficiently dispersed in an aqueous solution prepared by adding an appropriate amount of a water-soluble organic solvent such as alcohols to these waters, thereby enhancing a washing effect of removing impurities therefrom.

The water-washing treatment may be conducted by any ordinary industrial methods such as a washing method by decantation, a washing method by dilution using a filter thickener and a washing method of flowing water through a filter press.

The terminal point of the water-washing treatment may be determined by measuring an electric conductivity (CM value) of a water suspension of the carbon black or a filtrate thereof, specifically, the time at which the electric conductivity is reduced to 60 μS/cm or lower. When the electric conductivity is more than 60 μS/cm, the extent of washing the carbon black tends to be insufficient, so that it may be difficult to reduce a soluble sodium salt content therein to not more than 50 ppm in terms of Na and reduce a soluble sulfate content therein to not more than 100 ppm in terms of SO₄.

Further, when adding an aqueous alkali solution to a water suspension containing the carbon black previously subjected to the disaggregation treatment, and then subjecting the thus obtained alkaline suspension to heat treatment and then to water-washing treatment, it is possible to efficiently remove impurities, in particular, those impurities such as soluble sulfates which are difficult to remove by ordinary washing methods, from the carbon black.

The concentration of the carbon black in the alkaline suspension used upon the heat treatment is preferably 50 to 250 g/L.

Examples of the aqueous alkali solution usable in the present invention include aqueous solutions of alkali metal hydroxides and alkali earth metal hydroxides such as sodium hydroxide, potassium hydroxide and calcium hydroxide.

The pH value of the alkaline suspension containing the carbon black is not less than 13. When the pH value of the alkaline suspension is less than 13, it may be difficult to effectively remove impurities present within the carbon black particles and on the surface thereof. The upper limit of the pH value of the alkaline suspension is 14. In view of facilitated removal of the impurities present within the carbon black particles and on the surface thereof as well as a good effect of washing out the soluble sodium salts and soluble sulfates therefrom, the pH value of the alkaline suspension containing the carbon black is preferably in the range of 13.1 to 13.8.

The heating temperature of the alkaline suspension containing the carbon black is preferably not lower than 80° C. and more preferably not lower than 90° C. When the heating temperature of the alkaline suspension containing the carbon black is lower than 80° C., it may be difficult to effectively remove impurities present within the carbon black particles and on the surface thereof. The upper limit of the heating temperature of the alkaline suspension containing the carbon black is preferably 103° C. and more preferably 100° C. When the upper limit of the heating temperature is higher than 103° C., although impurities present within the carbon black particles and on the surface thereof such as the soluble sodium salts and soluble sulfates are effectively removed, the use of special apparatuses such as autoclave tends to be needed, or the solution to be treated tends to be boiled even under normal pressures, resulting in industrially disadvantageous process.

The carbon black heat-treated in the alkaline suspension is filtered and washed with water by ordinary methods to thereby remove the soluble sodium salts and soluble sulfates washed out from the inside and surface of the carbon black particles as well as impurities such as sodium which are adhered onto the surface of the carbon black particles during the heat treatment of the alkaline suspension, and then dried.

The coating of the surface of the respective non-magnetic particles for non-magnetic undercoat layer according to the present invention with the surface-modifying agent may be conducted by mechanically mixing and stirring the non-magnetic particles for non-magnetic undercoat layer together with the surface-modifying agent, or by mechanically mixing and stirring the non-magnetic particles for non-magnetic undercoat layer while spraying the surface-modifying agent thereonto. In these cases, a substantially whole amount of the surface modifying agent added can be applied onto the surface of the respective non-magnetic particles for non-magnetic undercoat layer.

Meanwhile, when using an alkoxysilane or a fluoroalkylsilane as the surface-modifying agent, the alkoxysilane or the fluoroalkylsilane may be coated in the form of an organosilane compound produced from the alkoxysilane or a fluorine-containing organosilane compound produced from the fluoroalkylsilane which are partially formed through the coating step. Even in such a case, the subsequent adhesion of the carbon black is not adversely affected.

In the present invention, in order to uniformly coat the surface of the respective non-magnetic particles for non-magnetic undercoat layer with the surface-modifying agent, it is preferred that agglomerates of the non-magnetic particles for non-magnetic undercoat layer are previously disaggregated by using a pulverizer.

As apparatuses for mixing and stirring the non-magnetic particles for non-magnetic undercoat layer according to the present invention with the surface-modifying agent, and as apparatuses for mixing and stirring the carbon black with the non-magnetic particles for non-magnetic undercoat layer whose surfaces are coated with the surface-modifying agent, there are preferably used those apparatus capable of applying a shear force to the particles, more preferably those apparatuses capable of conducting application of shear force, spatula-stroking and compression at the same time. As such apparatuses, there may be exemplified wheel-type kneaders, ball-type kneaders, blade-type kneaders, roll-type kneaders or the like. Among them, wheel-type kneaders are more effectively used for practicing the present invention.

Specific examples of the wheel-type kneaders include an edge runner (equivalent to a “mix muller”, a “Simpson mill” or a “sand mill”), a multi-mull, a Stotz mill, a wet pan mill, a Conner mill, a ring muller, or the like. Among them, an edge runner, a multi-mull, a Stotz mill, a wet pan mill and a ring muller are preferred, and an edge runner is more preferred. Specific examples of the ball-type kneaders include a vibration mill or the like. Specific examples of the blade-type kneaders include a Henschel mixer, a planetary mixer, a Nauter mixer or the like. Specific examples of the roll-type kneaders include an extruder or the like.

After coating the surface of the respective non-magnetic particles for non-magnetic undercoat layer according to the present invention with the surface-modifying agent, the carbon black is added to the thus coated non-magnetic particles, and resultant mixture is mixed and stirred to allow the carbon black to adhere onto the coating layer comprising the surface-modifying agent, followed by further subjecting the resultant particles to drying and heating treatments, if required.

The carbon black is preferably added little by little for a relatively long period of time, in particular, for about 5 to about 60 min.

If required, after adding the surface-modifying agent to the carbon black-adhered non-magnetic particles for non-magnetic undercoat layer and mixing and stirring the resultant mixture, additional carbon black may be further added to the thus obtained particles and then mixed and stirred therewith to allow the carbon black to adhere onto the first carbon black layer through the coating layer comprising the surface-modifying agent to form a second carbon black layer, or the above procedure may be repeated plural times to form two or more carbon black layers on the particles. As apparatuses for mixing and stirring the composite non-magnetic particles for non-magnetic undercoat layer formed by adhering one or more carbon black layers onto the non-magnetic particles for non-magnetic undercoat layer according to the present invention, the surface-modifying agent and the carbon black, there are preferably used those apparatus capable of applying a shear force to the particles, more preferably those apparatuses capable of conducting application of shear force, spatula-stroking and compression at the same time. As such apparatuses, there may be exemplified wheel-type kneaders, ball-type kneaders, blade-type kneaders, roll-type kneaders or the like. Among them, wheel-type kneaders are more effectively used for practicing the present invention. In addition, if required, the resultant particles may be further subjected to drying and heating treatments.

The heating temperature used in the drying and heating treatments is preferably 40 to 150° C. and more preferably 60 to 120° C., and the heating time is preferably 10 min to 24 hr and more preferably 30 min to 15 hr.

Next, the magnetic recording medium according to the present invention is described.

The magnetic recording medium of the present invention comprises a non-magnetic substrate, a non-magnetic undercoat layer formed on the non-magnetic substrate, and a magnetic recording layer formed on the non-magnetic undercoat layer. Also, if required, a back coat layer may be formed on the surface of the non-magnetic substrate which is opposed to the surface on which the magnetic recording layer is formed. In particular, back-up tapes used for recording in computers are preferably provided with such a back coat layer from the standpoints of preventing non-uniform winding and enhancing traveling durability.

Examples of the non-magnetic substrate used in the present invention include those generally used for current magnetic recording media, for example, synthetic films comprising polyesters such as polyethylene terephthalate and polyethylene naphthalate, polyolefins such as polyethylene and polypropylene, polycarbonates, polyamides, polyamide imides, polyimides, aromatic polyamides, aromatic polyimides, aromatic polyamide imides, polysulfones, cellulose triacetate and polybenzooxazole; metal foils or plates comprising aluminum, stainless steel, etc.; and various kinds of papers. In view of a strength of the obtained magnetic recording medium, among these materials, preferred are polyesters, polyamides and aromatic polyamides.

The thickness of the non-magnetic substrate varies depending upon materials and applications thereof, and is preferably 1.0 to 300 μm and more preferably 2.0 to 200 μm. In particular, in the case of the back-up tapes used for recording in computers which tend to be reduced in thickness for the purpose of increasing a recording capacity thereof, the thickness of the non-magnetic substrate is preferably 1.0 to 7.0 μm and more preferably 2.0 to 6.0 μm.

Next, the non-magnetic undercoat layer used in the magnetic recording medium of the present invention is described.

The non-magnetic undercoat layer provided in the magnetic recording medium of the present invention comprises the non-magnetic particles for non-magnetic undercoat layer or the composite non-magnetic particles for non-magnetic undercoat layer according to the present invention, and a binder resin. In addition, if required, the non-magnetic undercoat layer may also contain various additives ordinarily used for production of magnetic recording media such as lubricants, abrasives and antistatic agents.

As the binder resin, those resins ordinarily used for production of magnetic recording media such as thermoplastic resins, thermosetting resins and electron beam-curable resins may be used alone or in combination of any two or more thereof. Specific examples of the thermoplastic resins usable as the binder resin include vinyl chloride resins, vinyl chloride-vinyl acetate copolymers, vinyl chloride polymers, vinyl chloride-vinyl acetate-vinyl alcohol copolymers, vinyl chloride-vinyl alcohol copolymers, vinyl chloride-vinyl acetate-maleic acid copolymers, vinyl chloride-vinylidene acetate copolymers, vinyl chloride-acrylonitrile copolymers, acrylic acid ester-acrylonitrile copolymers, acrylic acid ester-vinylidene chloride copolymers, acrylic acid ester-styrene copolymers, methacrylic acid ester-acrylonitrile copolymers, methacrylic acid ester-vinylidene chloride copolymers, methacrylic acid ester-styrene copolymers, urethane elastomers, nylon-silicone-based resins, nitrocellulose-polyamide resins, polyvinylfluoride, vinylidene chloride-acrylonitrile copolymers, butadiene-acrylonitrile copolymers, polyamide resins, polyvinyl butyral, cellulose derivatives such as nitrocellulose, styrene-butadiene copolymers, (saturated) polyester resins, polycarbonate resins, chlorovinyl ether-acrylic acid copolymers, amino resins, and synthetic rubber-based resins such as polybutadiene. Specific examples of the thermosetting resins and electron beam-curable resins include phenol resins, phenoxy resins, epoxy resins, polyurethane resins, (unsaturated) polyester resins, polyurethane carbonate resins, urea resins, melamine resins, alkyd resins, silicone resins, polyisocyanates, and electron beam-curable acrylic urethane resins. The respective binder resins may contain a polar group including an acid group such as —COOM, —SO₃M and —OPO₂M₂ wherein M is H, an alkali metal, an alkali earth metal or a hydrocarbon group, an amphoteric group derived from phosphates or alkyl betaine-type compounds, —OH and —NH₂. In view of a good dispersibility of the non-magnetic particles for non-magnetic undercoat layer or the composite non-magnetic particles for non-magnetic undercoat layer according to the present invention in a vehicle, among these binder resins, preferred are those containing —COOM, —SO₃M or alkyl betaine-type amphoteric group as the polar group. In particular, in view of a good surface smoothness of the resultant tape, among these binder resins, more preferred are those containing —SO₃M.

The blending ratio between the non-magnetic particles for non-magnetic undercoat layer or the composite non-magnetic particles for non-magnetic undercoat layer according to the present invention, and the binder resin, is controlled such that the non-magnetic particles for non-magnetic undercoat layer or the composite non-magnetic particles for non-magnetic undercoat layer according to the present invention, are used in an amount of 5 to 2000 parts by weight and preferably 100 to 1000 parts by weight on the basis of 100 parts by weight of the binder resin.

The thickness of the non-magnetic undercoat layer as the coating film after the calendering treatment which is formed on the non-magnetic substrate is preferably 0.1 to 5.0 μm, more preferably 0.3 to 4.0 μm and still more preferably 0.5 to 3.0 μm. In particular, in the case of the back-up tapes used for recording in computers which tend to be reduced in thickness for the purpose of increasing a recording capacity thereof, the thickness of the non-magnetic undercoat layer is preferably 0.1 to 3.0 μm, more preferably 0.3 to 2.5 μm and still more preferably 0.5 to 2.0 μm. When the thickness of the non-magnetic undercoat layer is less than 0.1 μm, it may be difficult to improve a surface roughness of the non-magnetic substrate, and the resultant magnetic recording medium tends to be insufficient in strength. When the thickness of the non-magnetic undercoat layer is more than 5.0 μm, it may be difficult to reduce a whole thickness of the magnetic recording medium.

As the antistatic agent, there may be used conductive particles such as carbon black, graphite, tin oxide and a mixture of titanium oxide/tin oxide/antimony oxide, and surfactants. Among these antistatic agents, carbon black is preferred because it is expected to exhibit the effects of reducing friction coefficient and enhancing a strength of the obtained magnetic recording medium in addition to the antistatic effect. In view of a good storage property of the tape, highly-purified carbon black is more preferred.

The non-magnetic undercoat layer obtained by using the non-magnetic particles for non-magnetic undercoat layer or the composite non-magnetic particles for non-magnetic undercoat layer according to the present invention has a gloss of coating film of 175 to 280%, preferably 180 to 280% and more preferably 185 to 280%; a surface roughness Ra of coating film of 2.0 to 11.0 nm, preferably 2.0 to 10.5 nm and more preferably 2.0 to 10.0 nm; and a Young's modulus (relative value), as a strength of coating film, of 117 to 150 and preferably 119 to 150.

Next, the magnetic recording layer provided in the magnetic recording medium of the present invention is described.

The magnetic recording layer formed in the magnetic recording medium of the present invention comprises magnetic particles and a binder resin.

As the magnetic particles, there may be used any of cobalt-coated magnetic iron oxide particles obtained by coating Co, or Co and Fe, on magnetic iron oxide particles such as maghemite particles (γ-Fe₂O₃) and magnetite particles (FeOₓ.Fe₂O₃, O<x·1); cobalt-coated magnetic iron oxide particles obtained by incorporating other elements than Fe such as Co, Al, Ni, P, Zn, Si, B and rare earth metals into the above cobalt-coated magnetic iron oxide particles; magnetic metal particles containing iron as a main component; magnetic iron alloy particles containing other elements than Fe such as Co, Al, Ni, P, Zn, Si, B and rare earth metals; and plate-shaped magnetoplumbite-type ferrite particles containing Ba, Sr or Ba—Sr; plate-shaped magnetoplumbite-type ferrite particles obtained by incorporating into the above plate-shaped magnetoplumbite-type ferrite particles, one or more coercive force reducing agents selected from the group consisting of divalent and tetravalent metals such as Co, Ni, Zn, Mn, Mg, Ti, Sn, Zr, Nb, Cu and Mo.

Meanwhile, in consideration of recent short-wavelength recording and high-density recording, among the above magnetic particles, preferred are magnetic metal particles containing iron as a main component, magnetic iron alloy particles containing other elements than Fe such as Co, Al, Ni, P, Zn, Si, B and rare earth metals, and plate-shaped magnetoplumbite-type ferrite particles.

The magnetic particles have an average primary major axis diameter (average primary particle diameter in the case of plate-shaped particles) of preferably 0.01 to 0.50 μm and more preferably 0.02 to 0.30 μm. The magnetic particles are preferably acicular particles or plate-shaped particles. Here, the “acicular” shape means not only literally an acicular shape, but also a spindle shape and a rice grain-like shape.

The acicular magnetic particles have an aspect ratio of preferably not less than 2.0 and more preferably not less than 3.0. In consideration of a good dispersibility in a vehicle, the upper limit of the aspect ratio of the acicular magnetic particles is preferably 15.0 and more preferably 10.0.

The plate-shaped magnetic particles have a plate ratio (ratio of an average primary particle diameter to an average primary thickness of the particles; hereinafter referred to merely as the “plate ratio”) of preferably not less than 1.0 and more preferably not less than 2.0. In consideration of dispersibility in vehicle, the upper limit of the plate ratio of the plate-shaped magnetic particles is preferably 20.0 and more preferably 15.0.

As to the magnetic properties of the magnetic particles, the coercive force value thereof is usually 39.8 to 318.3 kA/m (500 to 4,000 Oe), preferably 43.8 to 318.3 kA/m (550 to 4,000 Oe); and the saturation magnetization value thereof is usually 40 to 200 Am²/kg (40 to 200 emu/g) and preferably 45 to 180 Am²/kg (45 to 180 emu/g).

In the case were the magnetic metal particles containing iron as a main component, the magnetic iron alloy particles, or the plate-shaped magnetoplumbite-type ferrite particles, are used as the magnetic particles in consideration of high-density recording, etc., as to the magnetic properties of these magnetic particles, the coercive force value thereof is usually 63.7 to 318.3 kA/m (800 to 4000 Oe) and preferably 71.6 to 318.3 kA/m (900 to 4000 Oe); and the saturation magnetization value thereof is usually 40 to 200 Am²/kg (40 to 200 emu/g) and preferably 45 to 180 Am²/kg (45 to 180 emu/g).

As the binder resin for the magnetic recording layer, there may be used the same binder resins as used for forming the above non-magnetic undercoat layer.

The thickness of the magnetic recording layer as the coating film formed on the non-magnetic undercoat layer after the calendering treatment is preferably 0.01 to 2.0 μm, more preferably 0.02 to 1.5 μm and still more preferably 0.02 to 1.0 μm. In particular, in the case of the back-up tapes used for recording in computers which tend to be reduced in thickness for enhancing a recording capacity thereof, the thickness of the magnetic recording layer is preferably 0.01 to 0.30 μm and more preferably 0.02 to 0.20 μm. When the thickness of the magnetic recording layer is less than 0.01 μm, it may be difficult to uniformly apply a coating material therefor, resulting in occurrence of undesirable phenomenon such as coating unevenness. When the thickness of the magnetic recording layer is more than 2.0 μm, the obtained magnetic recording layer tends to be deteriorated in reproduction output because of adverse influence by demagnetizing field.

The blending ratio of the magnetic particles and the binder resin in the magnetic recording layer is controlled such that the magnetic particles are used in an amount of usually 100 to 2000 parts by weight and preferably 200 to 1500 parts by weight on the basis of 100 parts by weight of the binder resin.

The magnetic recording layer may further contain ordinarily used additives such as lubricants, abrasives and antistatic agents.

As the antistatic agent, there may be used conductive particles such as carbon black, graphite, tin oxide and a mixture of titanium oxide/tin oxide/antimony oxide, and surfactants. Among these antistatic agents, carbon black is preferred for the same reasons as described above for formation of the above non-magnetic undercoat layer. In view of a good storage property of the tape, highly-purified carbon black is more preferred.

Next, the back coat layer provided in the magnetic recording medium of the present invention is described.

The back coat layer formed in the magnetic recording medium of the present invention preferably contains, in addition to the binder resin, an antistatic agent and inorganic particles for the purpose of reducing a surface resistivity and a light transmittance of the back coat layer and enhancing a strength thereof. The back coat layer may also contain various additives ordinarily used for magnetic recording media such as lubricants and abrasives, if required.

As the binder resin for the back coat layer, there may be used the same binder resins as used for forming the above non-magnetic undercoat layer and magnetic recording layer.

As the antistatic agent, there may be used conductive particles such as carbon black, graphite, tin oxide and a mixture of titanium oxide/tin oxide/antimony oxide, and surfactants. Among these antistatic agents, carbon black is preferred for the same reasons as described above for formation of the above non-magnetic undercoat layer and magnetic recording layer. In view of a good storage property of the tape, highly-purified carbon black is more preferred.

As the inorganic particles, there may be used one or more kinds of particles selected from the group consisting of particles of hematite, alumina, calcium carbonate, silicon carbide, cerium oxide, titanium oxide, silica, zinc oxide, boron nitride and barium sulfate.

In the case of the back-up tapes used for recording in computers which are narrowed in track width for enhancing a recording capacity thereof, they tend to suffer from deterioration in reproduction output owing to off-track, resulting in need of track servo system. The track servo system generally includes a magnetic servo system in which a servo track band formed on the magnetic recording layer or the back coat layer is magnetically read out, and an optical servo system in which a servo track band constituted of concaved arrays which is formed on the back coat layer by laser irradiation, etc., is optically read out.

In particular, in the case of the magnetic servo system in which the servo track band is formed on the back coat layer, it is inevitably required to incorporate magnetic particles, in addition to the antistatic agent and the inorganic particles, into the back coat layer. As the magnetic particles contained in the back coat layer, there may be used the same magnetic particles as used in the magnetic recording layer.

The thickness of the back coat layer as the coating film formed on the surface of the non-magnetic substrate which is opposed to the surface where the magnetic recording layer is formed, after subjected to the calendar treatment, is preferably 0.1 to 4.0 μm, more preferably 0.2 to 2.0 μm and still more preferably 0.2 to 1.5 μm. When the thickness of the back coat layer is less than 0.1 μm, the back coat layer tends to be insufficient in strength, or suffer from undesirable phenomenon such as coating unevenness. When the thickness of the back coat layer is more than 4.0 μm, the total thickness of the obtained tape tends to be large owing to too large thickness of the back coat layer, so that it may be difficult to realize a high recording capacity.

The magnetic recording medium obtained by using the magnetic particles according to the present invention has a coercive force value of preferably 39.8 to 318.3 kA/m (500 to 4000 Oe) and more preferably 43.8 to 318.3 kA/m (550 to 4000 Oe); a gloss of coating film of preferably 130 to 300%, more preferably 135 to 300% and still more preferably 140 to 300%; a surface roughness Ra of a coating film of preferably not more than 11.0 nm, more preferably 2.0 to 10.5 nm and still more preferably 2.0 to 10.0 nm; a Young's modulus of coating film of preferably 122 to 160 and more preferably 124 to 160; a friction coefficient of coating film of 0.05 to 0.30, preferably 0.05 to 0.28 and more preferably 0.05 to 0.26; and a drop-out (D/O) of coating film of preferably not more than 18 number/msec and more preferably not more than 16 number/msec. In addition, the rate of increase in friction coefficient after allowing the magnetic recording medium to stand at a temperature of 60° C. and a relative humidity of 90% for 14 days in order to examine a storage stability thereof, is preferably not more than 30% and more preferably not more than 24%. Further, the rate of increase in drop-out of coating film after allowing the magnetic recording medium to stand at a temperature of 60° C. and a relative humidity of 90% for 14 days is preferably not more than 10 number/msec and more preferably not more than 6 number/msec.

The magnetic recording medium obtained by using the acicular magnetic metal particles containing iron as a main component, the acicular magnetic iron alloy particles, or the plate-shaped magnetoplumbite-type particles as the magnetic particles in consideration of a high recording capacity thereof, has a coercive force value of preferably 63.7 to 318.3 kA/m (800 to 4000 Oe) and more preferably 71.6 to 318.3 kA/m (900 to 4000 Oe); a gloss of coating film of preferably 185 to 300%, more preferably 190 to 300% and still more preferably 195 to 300%; a surface roughness Ra of coating film of preferably not more than 8.0 nm, more preferably 2.0 to 7.5 nm and still more preferably 2.0 to 7.0 nm; a Young's modulus of preferably 124 to 160 and more preferably 126 to 160; a friction coefficient of 0.05 to 0.30, preferably 0.05 to 0.28 and more preferably 0.05 to 0.26; and a drop-out (D/O) of preferably not more than 16 number/msec and more preferably not more than 14 number/msec. In addition, the rate of increase in friction coefficient of coating film after allowing the magnetic recording medium to stand at a temperature of 60° C. and a relative humidity of 90% for 14 days in order to examine a storage stability thereof, is preferably not more than 26% and more preferably not more than 20%. Further, the rate of increase in drop-out of coating film after allowing the magnetic recording medium to stand at a temperature of 60° C. and a relative humidity of 90% for 14 days is preferably not more than 8 number/msec and more preferably not more than 4 number/msec.

Next, the process for producing the magnetic recording medium according to the present invention is described.

As the solvent used upon forming the non-magnetic undercoat layer, the magnetic recording layer and the back coat layer, there may be exemplified those solvents ordinarily used for production of magnetic recording media. Examples of the solvent include ketones such as acetone, methyl ethyl ketone, methyl isobutyl ketone, cyclohexanone and tetrahydrofuran; aromatic hydrocarbons such as toluene and xylene; alcohols such as methanol, ethanol, propanol, butanol, isobutyl alcohol and isopropyl alcohol; esters such as methyl acetate, butyl acetate, isobutyl acetate and glycol acetate; glycol ethers such as glycol dimethyl ether, glycol monoethyl ether and dioxane; and mixtures thereof.

The total amount of the solvents used is 65 to 1000 parts by weight on the basis of 100 parts by weight of the non-magnetic particles for non-magnetic undercoat layer or the composite non-magnetic particles for non-magnetic undercoat layer according to the present invention. When the total amount of the solvents used is less than 65 parts by weight, the obtained coating material tends to exhibit a excessively high viscosity, so that it may be difficult to apply such a highly-viscous coating material. When the total amount of the solvents used is more than 1000 parts by weight, the amount of the solvents vaporized upon forming the coating film tends to be too large and, therefore, disadvantageous from industrial viewpoints.

The respective coating materials for the non-magnetic undercoat layer, magnetic recording layer and back coat layer are prepared by subjecting the components of the respective layers and solvents to kneading and dispersing treatments using ordinary kneaders and dispersing apparatuses. The thus prepared coating materials for the non-magnetic undercoat layer and magnetic recording layer are successively applied on one surface of the non-magnetic substrate in the order of the non-magnetic undercoat layer and magnetic recording layer, dried and then subjected to calendering treatment. The coating method used for forming the non-magnetic undercoat layer and magnetic recording layer may be either a wet-on-wet method in which the coating materials for the non-magnetic undercoat layer and magnetic recording layer are applied substantially at the same time, or a wet-on-dry method in which after applying the coating material for the non-magnetic undercoat layer and then drying the resultant coating film, the coating material for the magnetic recording layer is applied thereonto. In addition, when forming the back coat layer according to the requirement, the coating material for the back coat layer is applied onto the surface of the non-magnetic substrate which is opposed to the surface where the non-magnetic undercoat layer and magnetic recording layer are formed, dried and then subjected to calendering treatment, thereby obtaining the aimed magnetic recording medium.

### <Effect>

The important point of the present invention resides in that the non-magnetic particles for non-magnetic undercoat layer according to the present invention which comprise hematite particles, an inner coating layer formed on the surface of the respective hematite particles which comprises a phosphorus-containing inorganic compound, and an outer coating layer formed on the inner coating layer which comprises an aluminum-containing inorganic compound, exhibit an adsorption of sodium dodecylbenzenesulfonate thereonto as high as not less than 1.00 mg/m² and an elution of iron ions therefrom as low as not more than 5 ppm in terms of Fe, and the magnetic recording medium obtained by using the non-magnetic particles even though the thickness of the non-magnetic undercoat layer is reduced, exhibits a good surface smoothness as a tape as well as an excellent storage property.

The reason why the magnetic recording medium obtained by using the non-magnetic particles for non-magnetic undercoat layer or the composite non-magnetic particles for non-magnetic undercoat layer according to the present invention exhibits a good surface smoothness as a tape even when the thickness of the non-magnetic undercoat layer is reduced, is considered by the present inventors as follows. That is, since the surface of the respective hematite particles is coated with the phosphorus-containing inorganic compound, and further the thus formed coating layer is coated with the aluminum-containing inorganic compound, the adsorption of a metal sulfonate group thereonto is enhanced, and the affinity of the particles to binder resins containing a metal sulfonate group which are ordinarily used for production of magnetic recording media is therefore increased, thereby improving a dispersibility of the non-magnetic particles for non-magnetic undercoat layer in a vehicle and preventing deterioration in surface smoothness even though the thickness of the non-magnetic undercoat layer is reduced.

In addition, the reason why the magnetic recording medium obtained by using the non-magnetic particles for non-magnetic undercoat layer or the composite non-magnetic particles for non-magnetic undercoat layer according to the present invention is excellent in storage property, is considered by the present inventors as follows. That is, since the surface of the respective hematite particles is coated with the phosphorus-containing inorganic compound, and further the thus formed coating layer is coated with the aluminum-containing inorganic compound, the elution of iron ions from the hematite particles can be suppressed even when exposed to high-temperature and high-humidity conditions. As a result, even when the tape is preserved for a long period of time, the fatty acid added for the purpose of ensuring a good traveling property of the tape is prevented from reacting with the iron ions and forming a fatty acid iron salt in the form of precipitates, resulting in less occurrence of increase in friction coefficient and drop-out of the tape.

The non-magnetic particles for non-magnetic undercoat layer of magnetic recording medium according to the present invention are excellent in affinity to binder resins containing a metal sulfonate group and prevented from undergoing elution of iron ions therefrom, and are therefore suitable as non-magnetic particles for non-magnetic undercoat layer of magnetic recording medium.

The magnetic recording medium of the present invention exhibits a good surface smoothness as a tape as well as a good storage property even though the thickness of the non-magnetic undercoat layer is reduced, and is therefore suitable as a high-density magnetic recording medium.

### EXAMPLES

The present invention is described in more detail by Examples and Comparative Examples.

The average primary major axis diameter, average primary minor axis diameter, average primary particle diameter and average primary thickness of the particles were measured by the following procedure. First, the particles were observed using a transmission electron microscope and photographed at a magnification controlled such that about 400 individual particles present in a visual field were dispersed in a non-overlapped and divided state. Next, after magnifying the obtained electron micrograph four times in each of longitudinal and transverse directions, the major axis diameters, minor axis diameters, particle diameters and thicknesses of about 350 particles observed on the enlarged micrograph were respectively measured using a DIGITIZER “Model: KD 4620” manufactured by Graphtec Co., Ltd., and the average primary major axis diameter, average primary minor axis diameter, average primary particle diameter and average primary thickness were expressed by average values of the respective measured values. Upon the measurement, the major axis diameters, minor axis diameters, particle diameters and thicknesses were respectively measured as largest ones of the individual particles. Also, those particles being unclear in contour or individually undistinguishable from each other owing to overlapping thereof were excluded from measurement of the particle sizes.

The aspect ratio of the particles was expressed by the ratio of average primary major axis diameter to average primary minor axis diameter thereof, and the plate ratio of the particles is expressed by the ratio of average primary particle diameter to average primary thickness thereof.

The specific surface areas of the particles was expressed by the value measured by a BET method.

The amounts of Al, P, SiO₂, Y and Zn which were present within goethite particles, hematite particles, non-magnetic particles for non-magnetic undercoat layer and composite non-magnetic particles for non-magnetic undercoat layer, or on the surface thereof, were respectively measured by a fluorescent X-ray analyzer “3063 M-Model” (manufactured by Rigaku Denki Kogyo Co., Ltd.) according to JIS K0119 “General rule of fluorescent X-ray analysis”. Also, the content of Co in the Co-coated magnetite particles and the Co-coated maghemite particles as well as the contents of Ti, Ni and Fe in the plate-shaped magnetoplumbite-type ferrite particles were measured by the same method as described above.

In the non-magnetic particles for non-magnetic undercoat layer according to the present invention, the P content and the Al content in the inner coating layer comprising the phosphorus-containing inorganic compound which was formed on the surface of the respective hematite particles and the outer coating layer comprising the aluminum-containing inorganic compound which was formed on the surface of the inner coating layer were calculated by subtracting the P content and Al content in the hematite particles from those in the non-magnetic particles for non-magnetic undercoat layer, respectively.

The amount of sodium dodecylbenzenesulfonate adsorbed onto the hematite particles, non-magnetic particles for non-magnetic undercoat layer or composite non-magnetic particles for non-magnetic undercoat layer, was determined by the following method.

First, sample particles were dried in a dryer at 60° C. for 1 hr. Next, 9 g of the thus dried sample particles together with 100 g of 1.5 mmφ glass beads and a mixed solvent (comprising methyl ethyl ketone, toluene and cyclohexanone at a mixing ratio of 7:7:4) containing sodium dodecylbenzenesulfonate in an amount capable of forming merely one coating layer thereof on the surface of the respective sample particles, were charged into a 140-mL glass bottle, and mixed and dispersed for 60 min using a paint shaker.

Next, the resultant mixed dispersion was taken out and placed in a 50-mL precipitation tube, and subjected to centrifugal separation at 10000 rpm for 15 min to separate the dispersion into a solid portion and a solvent portion. The concentration of sodium dodecylbenzenesulfonate contained in the solvent portion was quantitatively determined by a gravimetric method. The thus measured amount of sodium dodecylbenzenesulfonate contained in the solvent portion was subtracted from the amount of sodium dodecylbenzenesulfonate initially charged to determine the amount of sodium dodecylbenzenesulfonate contained in the solid portion. From the thus measured amount of sodium dodecylbenzenesulfonate contained in the solid portion and the specific surface area of the sample particles, the amount (mg/m²) of sodium dodecylbenzenesulfonate adsorbed per 1 m² of a surface area of the sample particles was calculated.

The amount of iron ions eluted from the hematite particles, non-magnetic particles for non-magnetic undercoat layer or composite non-magnetic particles for non-magnetic undercoat layer, was determined as follows. That is, 2 g of the sample particles were charged into 50 mL of an ethanol solution of purified benzohydroxamic acid, and held in a constant-temperature water bath at 60° C. for 6 hr while shaking. Thereafter, the resultant solution was subjected to centrifugal separation to separate a supernatant therefrom, and the supernatant was analyzed using a spectrophotometer “UV-VIS” to measure an absorbance thereof at 440 nm. From the amount of a benzohydroxamic acid/iron complex formed by the reaction between the benzohydroxamic acid and the iron ions which exhibits an absorption peak near 440 nm, and a calibration curve of the absorbance, the amount (ppm) of iron ions eluted per a unit mass of the sample particles was calculated.

The magnetic properties of the magnetic particles were measured using a vibration sample magnetometer “VSM-3S-15” manufactured by Toei Kogyo Co., Ltd., by applying an external magnetic field of 795.8 kA/m (10 kOe) thereto (the magnetic properties of the Co-coated magnetic ion oxide particles were measured by applying an external magnetic field of 397.9 kA/m (5 kOe) thereto). Whereas, various properties of the magnetic tape were measured by applying an external magnetic field of 795.8 kA/m (10 kOe) thereto (when using the Co-coated magnetic ion oxide particles as the magnetic particles therein, the properties of the magnetic tape were measured by applying an external magnetic field of 397.9 kA/m (5 kOe) thereto).

The gloss of surface of the coating film was measured by irradiating light thereto at an incident angle of 45° using a gloss meter “UGV-5D” manufactured by Suga Testing Machines Manufacturing Co., Ltd., and expressed by a percentage (%) on the basis of a gloss of a standard plate as 86.3%.

The surface roughness Ra was determined by measuring a center line average roughness of the coating film using a surface roughness tester “Surfcom-575A” manufactured by Tokyo Seimitsu Co., Ltd.

The strength of the coating film was expressed by a Young's modulus thereof measured using “AUTOGRAPH” manufactured by Shimadzu Seisakusho Co., Ltd. Specifically, the strength of the coating film was expressed by a relative value of the Young's modulus obtained by comparing the measured Young's modulus value with that of a commercially available video tape “AV T-120” manufactured by Nihon Victor Co., Ltd. The higher the relative value, the higher the strength of the coating film.

The friction coefficient of the magnetic recording medium was expressed by the ratio of a friction force between the surface of the magnetic tape and a metal surface (aluminum mirror surface) which was measured using a tensile tester “TENSILON” manufactured by Shimadzu Seisakusho Co., Ltd., to a load applied.

The drop-out of the magnetic recording medium was determined by counting the number of drop-outs per unit time which were generated in an envelope obtained upon traveling the magnetic tape on a drum tester “BX-3168” manufactured by Beldex Corp., at a relative speed of 2.5 m/sec.

The storage stability of the magnetic tape was determined as follows. That is, after preserving the magnetic tape at a temperature of 60° C. and a relative humidity of 90% for 14 days, the friction coefficient and drop-out of the magnetic recording medium were measured and calculated under the same conditions as those before preserved, and the storage stability was expressed by the rates of increase in friction coefficient and drop-out after preserved relative to those before preserved.

The thicknesses of the non-magnetic substrate, non-magnetic undercoat layer and magnetic recording layer of the magnetic recording medium were measured by the following method.

That is, the thickness (A) of the non-magnetic substrate was first measured using a digital electron micrometer “K-351C” manufactured by Anritsu Denki Co., Ltd. Then, the thickness (B) of the non-magnetic substrate with the non-magnetic undercoat layer formed thereon (i.e., the total thickness of the non-magnetic substrate and the non-magnetic undercoat layer) was measured by the same method as above. Further, the thickness (C) of the magnetic recording medium produced by forming the magnetic recording layer on the non-magnetic undercoat layer (i.e., the total thickness of the non-magnetic substrate, the non-magnetic undercoat layer and the magnetic recording layer) was measured by the same method as above. The thicknesses of the non-magnetic undercoat layer was expressed by (B)-(A), and the thickness of the magnetic recording layer was expressed by (C)-(B).

In the case of the magnetic recording medium in which the back coat layer was formed on the surface of the non-magnetic substrate which was opposed to the surface where the magnetic recording layer was formed, in the same manner as described above, the thickness (A) of the non-magnetic substrate was first measured using a digital electron micrometer “K-351C” manufactured by Anritsu Denki Co., Ltd. Then, the thickness (B) of the non-magnetic substrate with the non-magnetic undercoat layer formed thereon (i.e., the total thickness of the non-magnetic substrate and the non-magnetic undercoat layer) was measured by the same method as above. Further, the thickness (C) of the magnetic recording medium produced by forming the magnetic recording layer on the non-magnetic undercoat layer (i.e., the total thickness of the non-magnetic substrate, the non-magnetic undercoat layer and the magnetic recording layer) was measured by the same method as above. Furthermore, the thickness (D) of the magnetic recording medium produced by forming the back coat layer on the surface of the non-magnetic substrate which was opposed to the surface where the non-magnetic undercoat layer and the magnetic recording layer were formed (i.e., the total thickness of the non-magnetic substrate, the non-magnetic undercoat layer, the magnetic recording layer and the back coat layer) was measured by the same method as above. The thicknesses of the non-magnetic undercoat layer was expressed by (B)-(A), the thickness of the magnetic recording layer was expressed by (C)-(B), and the thickness of the back coat layer was expressed by (D)-(C).

### Example 1-1

### Production of Non-Magnetic Particles for Non-Magnetic Undercoat Layer

550 L of a slurry (solid concentration: 31 g/L) containing 17 kg of a precursor 1 obtained by using an aqueous ferrous sulfate solution and a mixed aqueous solution containing sodium hydroxide and sodium carbonate (kind: goethite particles; particle shape: spindle shape; average primary major axial diameter: 0.130 μm; average primary minor axial diameter: 0.0170 μm; aspect ratio: 7.6; BET specific surface area: 145.4 m²/g; phosphorus content (in terms of P): 0.01% by weight; aluminum content (in terms of Al): 0.05% by weight) was heated to 60° C., and the pH value of the slurry was adjusted to 10.0 by adding a 0.1N NaOH aqueous solution thereto.

Next, an aqueous solution prepared by dissolving 400 g of sodium hexametaphosphate as an anti-sintering agent in water was gradually added to the above obtained alkaline slurry, and after completion of the addition, the resultant slurry was aged for 60 min. The pH value of the slurry was then adjusted to 6.5 by adding a 0.1N acetic acid solution thereto. Thereafter, the slurry was filtered, washed with water and then dried by ordinary methods, thereby producing 16 kg of goethite particles whose surface was coated with the phosphorus compound. The phosphorus content in the thus obtained goethite particles was 0.70% by weight in terms of P.

Next, the thus obtained goethite particles were charged into a ceramic rotary furnace, and subjected to heat-dehydration treatment in air at 340° C. for 60 min while rotating the furnace to remove water therefrom, thereby obtaining low-density hematite particles.

Next, 13 kg of the thus obtained low-density hematite particles were charged again into a ceramic rotary furnace, and heat-treated in air at 570° C. for 30 min while rotating the furnace so as to fill and seal dehydration pores formed therein. The resultant high-density hematite particles (particles 1) were spindle-shaped particles having an average primary major axial diameter of 0.094 μm, an average primary minor axial diameter of 0.0160 μm, an aspect ratio of 5.9, a BET specific surface area of 55.6 m²/g, a phosphorus content (in terms of P) of 0.63% by weight; an aluminum content (in terms of Al) of 0.07% by weight; a silicon content (in terms of SiO₂) of 0.02% by weight; a yttrium content (in terms of Y) of 0.01% by weight; an adsorption of sodium dodecylbenzenesulfonate thereinto of 0.91 mg/m²; and an elution of iron ions therefrom of 45.2 ppm.

12 kg of the hematite particles (particles 1) were disaggregated in 70 L of pure water using a stirrer to loosen agglomerates thereof, and further passed through a “TK Pipeline Homomixer” (tradename) manufactured by Tokushu-Kika Kogyo, Co., Ltd., three times, thereby obtaining a slurry containing the hematite particles.

Successively, the slurry containing the hematite particles was passed through a horizontal-type sand grinder “MIGHTY MILL MHG-1.5L” (tradename) manufactured by Inoue Seisakusho Co., Ltd., operated at an axis rotating speed of 2000 rpm, five times, thereby obtaining a dispersed slurry containing the hematite particles.

After adjusting the concentration of the obtained dispersed slurry containing the hematite particles to 62 g/L, 180 L of the slurry was sampled. A 6N NaOH aqueous solution was added to the slurry under stirring so as to adjust the pH value of the slurry to 13.4. The slurry was then heated to 95° C. under stirring, and was held at the same temperature for 3 hr.

Next, the resultant slurry was washed with water by a decantation method to adjust the pH value of the slurry to 10.5. At this time, the weight of the hematite particles contained in the slurry was 10.5 kg.

Next, into the thus obtained alkaline slurry was gradually added 371.0 g of a phosphoric acid aqueous solution (concentration: 85% by weight), and after completion of the addition, the slurry was aged for 20 min. Then, the slurry was mixed with a 0.1N acetic acid solution to adjust the pH value of the slurry to 6.5. Thereafter, the slurry was filtered out, washed with water and then dried by ordinary methods.

The thus obtained hematite particles (particles 6) whose surface was coated with the phosphorus-containing inorganic compound were spindle-shaped particles having an average primary major axial diameter of 0.094 μm, an average primary minor axial diameter of 0.0161 μm, an aspect ratio of 5.8, a BET specific surface area of 56.2 m²/g, a phosphorus content (in terms of P) of 1.58% by weight; an aluminum content (in terms of Al) of 0.06% by weight; a silicon content (in terms of SiO₂) of 0.02% by weight; a yttrium content (in terms of Y) of 0.01% by weight; a zinc content (in terms of Zn) of 0.01% by weight; and a phosphorus content in the phosphorus-containing coating layer (in terms of P) of 0.95% by weight. 12 kg of the thus obtained hematite particles were disaggregated in 70 L of pure water using a stirrer to loosen agglomerates thereof, and further passed through a “TK Pipeline Homomixer” (tradename) manufactured by Tokushu-Kika Kogyo, Co., Ltd., three times, thereby obtaining a slurry containing the hematite particles.

Successively, the slurry containing the hematite particles was passed through a horizontal-type sand grinder “MIGHTY MILL MHG-1.5L” (tradename) manufactured by Inoue Seisakusho Co., Ltd., operated at an axis rotating speed of 2000 rpm, five times, thereby obtaining a dispersed slurry containing the hematite particles.

Next, into the thus obtained slurry was gradually added 344.9 g of sodium aluminate, and the slurry was aged for 20 min. Then, the slurry was mixed with a 0.1N acetic acid solution to adjust the pH value of the slurry to 6.5. Thereafter, the slurry was filtered, washed with water and then dried by ordinary methods. 10 kg of the resultant dried particles were charged into an edge runner “MPUV-2 Model” (tradename) manufactured by Matsumoto Chuzo Tekkosho Co., Ltd., and mixed and stirred at 392 N/cm for 20 min to lightly disaggregate agglomerates of the particles, thereby obtaining non-magnetic particles for non-magnetic undercoat layer which comprised the hematite particles, an inner coating layer formed on the respective hematite particles which comprised the phosphorus-containing inorganic compound, and an outer coating layer formed on the surface of the inner coating layer which comprised the aluminum-containing inorganic compound.

The thus obtained non-magnetic particles for non-magnetic undercoat layer which comprised the hematite particles, the inner coating layer formed on the respective hematite particles which comprised the phosphorus-containing inorganic compound, and the outer coating layer formed on the surface of the inner coating layer which comprised the aluminum-containing inorganic compound (particles of Example 1-1) were spindle-shaped particles having an average primary major axial diameter of 0.094 μm, an average primary minor axial diameter of 0.0161 μm, an aspect ratio of 5.8, a BET specific surface area of 56.5 m²/g, a phosphorus content (in terms of P) of 1.59% by weight; an aluminum content (in terms of Al) of 1.15% by weight; a silicon content (in terms of SiO₂) of 0.02% by weight; a yttrium content (in terms of Y) of 0.01% by weight; a zinc content (in terms of Zn) of 0.01% by weight; an aluminum content in the aluminum-containing coating layer (in terms of Al) of 1.09% by weight; a ratio of Al content in the outer coating layer comprising the aluminum-containing inorganic compound to P content in the inner coating layer comprising the phosphorus-containing inorganic compound (Al/P ratio) of 1.15; an adsorption of sodium dodecylbenzenesulfonate thereinto of 1.27 mg/m²; and an elution of iron ions therefrom of 2.8 ppm.

### <Non-Magnetic Undercoat Layer 1: Production of Non-Magnetic Undercoat Layer>

12 g of the particles of Example 1-1 as non-magnetic particles for non-magnetic undercoat layer were mixed with a binder resin solution (containing 30% by weight of a vinyl chloride-based copolymer resin having a potassium sulfonate group, and 70% by weight of cyclohexanone) and cyclohexanone. The resultant mixture was kneaded for 30 min using an automatic mortar, thereby obtaining a kneaded material.

The obtained kneaded material together with 95 g of 1.5 mmφ glass beads, an additional amount of a binder resin solution (containing 30% by weight of a polyurethane resin having a sodium sulfonate group, and 70% by weight of a mixed solvent containing methyl ethyl ketone and toluene at a mixing ratio of 1:1), cyclohexanone, methyl ethyl ketone and toluene, were charged into a 140-mL glass bottle. The resultant mixture was mixed and dispersed for 6 hr using a paint shaker, thereby obtaining a coating composition. The thus obtained coating composition was mixed with a lubricant and a curing agent. The resultant mixture was further mixed and dispersed for 15 min using a paint shaker, and then passed through a filter having an average pore size of 3 μm, thereby obtaining a non-magnetic coating material for non-magnetic undercoat layer.

The resultant non-magnetic coating material for non-magnetic undercoat layer had the following composition.

| | | |
|---|---|---|
| Non-magnetic particles for non-magnetic | 100.0 | parts by weight |
| undercoat layer | | |
| Vinyl chloride-based copolymer resin | 11.8 | parts by weight |
| having a potassium sulfonate group | | |
| Polyurethane resin having a sodium | 11.8 | parts by weight |
| sulfonate group | | |
| Cyclohexanone | 78.3 | parts by weight |
| Methyl ethyl ketone | 195.8 | parts by weight |
| Toluene | 117.5 | parts by weight |
| Curing agent (polyisocyanate) | 3.0 | parts by weight |
| Lubricant (butyl stearate) | 1.0 | part by weight |

The obtained non-magnetic coating material for non-magnetic undercoat layer was applied onto a 4.5 μm-thick aromatic polyamide film and then dried, thereby forming a non-magnetic undercoat layer. To evaluate properties of the thus formed non-magnetic undercoat layer, a half of the thus obtained coating film piece was subjected to calendering treatment and then to curing reaction at 60° C. for 24 hr.

As a result, it was confirmed that the thus obtained non-magnetic undercoat layer had a thickness of 1.7 μm, a gloss of coating film of 210%, a surface roughness Ra of 5.3 nm and a Young's modulus (relative value) of 130.

### Example 2-1

### Production of Magnetic Recording Medium

Twelve grams of the magnetic particles (1) (kind: magnetic metal particles containing iron as a main component; particle shape: acicular shape; average primary major axis diameter: 0.063 μm; average primary minor axis diameter: 0.0116 μm; aspect ratio: 5.4; coercive force value: 187.0 kA/m (2,350 Oe), saturation magnetization value: 131.8 Am²/kg (131.8 emu/g)) were mixed with 1.2 g of an abrasive “AKP-50” (tradename) produced by Sumitomo Chemical Corp., 0.12 g of carbon black 1, a binder resin solution (containing 30% by weight of a vinyl chloride-based copolymer resin having a potassium sulfonate group, and 70% by weight of cyclohexanone) and cyclohexanone. The resultant mixture was kneaded for 30 min using an automatic mortar, thereby obtaining a kneaded material.

The carbon black 1 used above was obtained by the following high-purification treatment. That is, commercially available carbon black (particle shape: granular shape; average primary particle diameter: 0.025 μm; BET specific surface area value: 85.6 m²/g; DBP oil absorption: 55 mL/100 g; soluble sodium salt content (in terms of Na): 147 ppm; soluble sulfate content (in terms of SO₄): 1105 ppm) were disaggregated using an edge runner “MPUV-2 Model” (tradename) manufactured by Matsumoto Chuzo Tekkosho Co., Ltd. Two kilograms of the thus disaggregated carbon black was mixed with water to obtain a slurry having a concentration of 98 g/L. The obtained slurry was then mixed with a 18N NaOH aqueous solution while stirring to adjust the pH value of the slurry to 13.7. Next, the resultant slurry was heated 95° C. while stirring and held at the same temperature for 180 min. Thereafter, the slurry was washed with pure water by a decantation method. The thus water-washed slurry was filtered using a Buchner funnel, and then washed by passing pure water therethrough until an electric conductivity of the filtrate was reduced to not more than 60 μS/cm. Thereafter, the separated solids were dried and then pulverized, thereby obtaining the high-purity carbon black 1.

The thus obtained carbon black 1 had an average primary particle diameter of 0.025 μm; a BET specific surface area value of 82.3 m²/g; a DBP oil absorption of 49 mL/100 g; a soluble sodium salt content (in terms of Na) of 20 ppm; and a soluble sulfate content (in terms of SO₄): 42 ppm.

The obtained kneaded material together with 95 g of 1.5 mmφ glass beads, an additional amount of a binder resin solution (containing 30% by weight of a polyurethane resin having a sodium sulfonate group, and 70% by weight of a mixed solvent containing methyl ethyl ketone and toluene at a mixing ratio of 1:1), cyclohexanone, methyl ethyl ketone and toluene, were charged into a 140-mL glass bottle. The resultant mixture was mixed and dispersed for 6 hr using a paint shaker, thereby obtaining a magnetic coating material. Then, the obtained coating material was mixed with a lubricant and a curing agent, and the resultant mixture was mixed and dispersed for 15 min using a paint shaker. Thereafter, the obtained mixture was filtered through a filter having an average pore size of 3 μm, thereby producing a magnetic coating material for magnetic recording layer.

The obtained magnetic coating material for magnetic recording layer had the following composition.

| | | |
|---|---|---|
| Magnetic metal particles containing | 100.0 | parts by weight |
| iron as a main component | | |
| Vinyl chloride-based copolymer resin | 10.0 | parts by weight |
| having a potassium sulfonate group | | |
| Polyurethane resin having a sodium | 10.0 | parts by weight |
| sulfonate group | | |
| Abrasive (AKP-50) | 10.0 | parts by weight |
| Carbon black 1 | 1.0 | part by weight |
| Lubricant (myristic acid:butyl | 3.0 | parts by weight |
| stearate = 1:2) | | |
| Curing agent (polyisocyanate) | 5.0 | parts by weight |
| Cyclohexanone | 65.8 | parts by weight |
| Methyl ethyl ketone | 164.5 | parts by weight |
| Toluene | 98.7 | parts by weight |

Then, the obtained coating material for magnetic recording layer was applied onto the non-magnetic undercoat layer, and oriented in a magnetic field and then dried.

### <Production of Back Coat Layer>

Twelve grams of the carbon black 1, 1.8 g of carbon black 2 (average primary particle size: 0.37 μm) and 1.8 g of iron oxide were mixed with a binder resin solution (containing 30% by weight of nitrocellulose and 70% by weight of cyclohexanone) and cyclohexanone. The resultant mixture was kneaded for 30 min using an automatic mortar, thereby obtaining a kneaded material. Meanwhile, the carbon black 2 was obtained by subjecting carbon black having an average primary particle size of 0.37 μm to high-purification treatment under the same washing conditions as used for the carbon black 1, and had a soluble sodium salt content of 18 ppm in terms of Na; and a soluble sulfate content of 25 ppm in terms of SO₄.

The obtained kneaded material together with 95 g of 1.5 mmφ glass beads, an additional amount of a binder resin solution (containing 30% by weight of a polyurethane resin having a sodium sulfonate group, and 70% by weight of a mixed solvent containing methyl ethyl ketone and toluene at a mixing ratio of 1:1), cyclohexanone, methyl ethyl ketone and toluene, were charged into a 140-mL glass bottle. The resultant mixture was mixed and dispersed for 6 hr using a paint shaker, thereby obtaining a back coat coating material. Then, the obtained coating material was further mixed with a lubricant and a curing agent, and the resultant mixture was further mixed and dispersed for 15 min using a paint shaker. Thereafter, the obtained mixture was filtered through a filter having an average pore size of 3 μm, thereby producing a coating material for back coat layer.

The obtained coating material for back coat layer had the following composition.

| | | |
|---|---|---|
| Carbon black 1 (primary particle | 100.0 | parts by weight |
| diameter: 0.025 μm) | | |
| Carbon black 2 (primary particle | 15.0 | parts by weight |
| diameter: 0.37 μm) | | |
| Iron oxide | 15.0 | parts by weight |
| Nitrocellulose resin | 55.0 | parts by weight |
| Polyurethane resin having a sodium | 35.0 | parts by weight |
| sulfonate group | | |
| Curing agent (polyisocyanate) | 18.0 | parts by weight |
| Cyclohexanone | 325.0 | parts by weight |
| Methyl ethyl ketone | 655.0 | parts by weight |
| Toluene | 325.0 | parts by weight |

The thus obtained coating material for back coat layer was applied onto the surface of the non-magnetic substrate which was opposite to the surface where the magnetic recording layer was formed, and after drying, the resultant coating layer was subjected to calendering treatment, thereby forming a back coat layer having a thickness of 0.5 μm. Thereafter, the resultant material was subjected to curing reaction at 60° C. for 24 hr, and then slit into 12.7 mm in width, thereby obtaining a magnetic recording medium.

The thus obtained magnetic recording medium was provided with the magnetic recording layer having a thickness of 0.27 μm, and had a coercive force value of 194.2 kA/m (2,440 Oe), a gloss of 222%, a surface roughness Ra of 5.1 nm, a Young's modulus (relative value) of 140, a friction coefficient of 0.20 and D/O of 8 /msec. In addition, it was confirmed that the rate of increase in friction coefficient of the coating film (between before and after preserved at a temperature of 60° C. and a relative humidity of 90% for 14 days) of 15%, and the rate of increase in D/O of the coating film (between before and after preserved at a temperature of 60° C. and a relative humidity of 90% for 14 days) of 2/msec.

The procedures as defined in “Example 1-1”, “Non-magnetic undercoat layer 1” and “Example 2-1” were conducted, thereby producing the non-magnetic particles for non-magnetic undercoat layer, the non-magnetic undercoat layer and the magnetic recording medium. Essential production conditions as well as various properties of the obtained non-magnetic particles for non-magnetic undercoat layer, non-magnetic undercoat layer and magnetic recording medium are shown below.

### Precursor 2 to 4:

The following precursors 2 to 4 as goethite particles used for producing hematite particles were prepared. Various properties of the goethite particles are shown in Table 1.

TABLE 1

| | Properties of goethite particles | | |
|---|---|---|---|
| | | Average | Average |
| | | primary | primary |
| | | major axial | minor axial |
| Kinds of | Particle | diameter | diameter |
| precursors | shape | (μm) | (μm) |
| Precursor 1 | Spindle- | 0.130 | 0.0170 |
| | shaped | | |
| Precursor 2 | Spindle- | 0.086 | 0.0126 |
| | shaped | | |
| Precursor 3 | Spindle- | 0.062 | 0.0101 |
| | shaped | | |
| Precursor 4 | Acicular | 0.173 | 0.0230 |

| | Properties of goethite particles | | | |
|---|---|---|---|---|
| | | BET | | |
| | Aspect | specific | P | Al |
| Kinds of | ratio | surface | content | content |
| precursors | (—) | area (m²/g) | (wt %) | (wt %) |
| Precursor 1 | 7.6 | 145.4 | 0.01 | 0.05 |
| Precursor 2 | 6.8 | 150.5 | 0.01 | 0.70 |
| Precursor 3 | 6.1 | 189.5 | 0.01 | 2.51 |
| Precursor 4 | 7.5 | 110.4 | 0.01 | 0.04 |

### Particles 2 to 5:

The same procedure for production of the particles 1 as defined above was conducted except that kinds of goethite particles as the precursor, kinds and amounts of anti-sintering agent added, temperature and time used in the low-density heat treatment, and temperature and time used in the high-density heat treatment, were changed variously, thereby obtaining hematite particles.

Essential production conditions are shown in Table 2, and various properties of the obtained hematite particles are shown in Table 3.

TABLE 2

Anti-sintering treatment

| | Kind of | | | |
|---|---|---|---|---|
| Kinds of | goethite | | In | Coating |
| hematite | particles | | terms | amount |
| particles | used | Kind | of | (wt %) |
| Particles 1 | Precursor 1 | Sodium | P | 0.70 |
| | | hexameta- | | |
| | | phosphate | | |
| Particles 2 | Precursor 2 | Water | SiO₂ | 1.60 |
| | | glass #3 | | |
| Particles 3 | Precursor 3 | Yttrium | Y | 1.75 |
| | | nitrate | | |
| Particles 4 | Precursor 4 | Ortho- | P | 0.60 |
| | | phosphoric | | |
| | | acid | | |
| Particles 5 | Precursor 1 | Sodium | Al | 0.98 |
| | | aluminate | | |

| | Low-density heat | | High-density heat | |
|---|---|---|---|---|
| Kinds of | treatment | | treatment | |
| hematite | Temp. | Time | Temp. | Time |
| particles | (° C.) | (min) | (° C.) | (min) |
| Particles 1 | 340 | 60 | 570 | 30 |
| Particles 2 | 320 | 60 | 580 | 30 |
| Particles 3 | 320 | 80 | 630 | 30 |
| Particles 4 | 360 | 60 | 600 | 30 |
| Particles 5 | 340 | 60 | 610 | 30 |

TABLE 3

Properties of hematite particles

| | | Average | Average | |
|---|---|---|---|---|
| | | primary | primary | |
| Kinds of | | major axis | minor axis | Aspect |
| hematite | Particle | diameter | diameter | ratio |
| particles | shape | (μm) | (μm) | (—) |
| Particles 1 | Spindle- | 0.094 | 0.0160 | 5.9 |
| | shaped | | | |
| Particles 2 | Spindle- | 0.069 | 0.0110 | 6.3 |
| | shaped | | | |
| Particles 3 | Spindle- | 0.041 | 0.0073 | 5.7 |
| | shaped | | | |
| Particles 4 | Acicular | 0.142 | 0.0209 | 6.8 |
| Particles 5 | Spindle- | 0.096 | 0.0163 | 5.9 |
| | shaped | | | |

| | Properties of hematite particles | | | |
|---|---|---|---|---|
| | BET | | | |
| Kinds of | specific | P | Al | SiO₂ |
| hematite | surface | content | content | content |
| particles | area (m²/g) | (wt %) | (wt %) | (wt %) |
| Particles 1 | 55.6 | 0.63 | 0.07 | 0.02 |
| Particles 2 | 75.3 | 0.01 | 0.78 | 1.58 |
| Particles 3 | 89.6 | 0.01 | 2.72 | 0.03 |
| Particles 4 | 49.8 | 0.56 | 0.04 | 0.02 |
| Particles 5 | 56.1 | 0.01 | 1.05 | 0.02 |

| | Properties of hematite particles | | |
|---|---|---|---|
| | | Adsorption | |
| | | of sodium | Elution |
| Kinds of | Y | dodecylbenzene- | of iron |
| hematite | content | sulfonate | ions |
| particles | (wt %) | (mg/m²) | (ppm) |
| Particles 1 | 0.01 | 0.91 | 45.2 |
| Particles 2 | 0.01 | 0.95 | 58.9 |
| Particles 3 | 1.89 | 0.96 | 72.8 |
| Particles 4 | 0.01 | 0.84 | 32.1 |
| Particles 5 | 0.01 | 0.88 | 28.7 |

### Particles 7 to 10:

The same procedure for production of the particles 6 as defined above was conducted except that kinds of hematite particles and kinds and amounts of surface-treating additives, were changed variously, thereby obtaining hematite particles.

Essential production conditions are shown in Table 4, and various properties of the obtained hematite particles are shown in Table 5.

TABLE 4

| | Surface treatment step | | | | | |
|---|---|---|---|---|---|---|
| | Kind of | Additives | | | Coating | |
| Kinds of | hematite | | In | | material | |
| hematite | particles | | terms | Amount | | Amount |
| particles | used | Kind | of | (wt %) | Kind | (wt %) |
| Particles | Particles | Phosphoric | H₃PO₄ | 3.0 | P | 0.95 |
| 6 | 1 | acid | | | | |
| Particles | Particles | Sodium | NaPO₃ | 4.0 | P | 1.20 |
| 7 | 2 | hexameta- | | | | |
| | | phosphate | | | | |
| Particles | Particles | Sodium | NaPO₃ | 3.8 | P | 1.16 |
| 8 | 3 | hexameta- | | | | |
| | | phosphate | | | | |
| Particles | Particles | Phos- | H₃PO₄ | 1.9 | P | 0.59 |
| 9 | 4 | phoric | | | | |
| | | acid | | | | |
| Particles | Particles | Sodium | Na₂Al₂O₄ | 1.8 | Al | 1.10 |
| 10 | 1 | aluminate | | | | |

TABLE 5

| | Properties of non-magnetic particles for | | | |
|---|---|---|---|---|
| | non-magnetic undercoat layer | | | |
| | Average | Average | | |
| | primary | primary | | BET |
| Kinds of | major axis | minor axis | Aspect | specific |
| hematite | diameter | diameter | ratio | surface |
| particles | (μm) | (μm) | (—) | area (m²/g) |
| Particles 6 | 0.094 | 0.0161 | 5.8 | 56.2 |
| Particles 7 | 0.070 | 0.0111 | 6.3 | 76.1 |
| Particles 8 | 0.043 | 0.0074 | 5.8 | 90.7 |
| Particles 9 | 0.143 | 0.0210 | 6.8 | 49.8 |
| Particles 10 | 0.095 | 0.0162 | 5.8 | 57.2 |

| | Properties of non-magnetic particles for | | |
|---|---|---|---|
| | non-magnetic undercoat layer | | |
| Kinds of | P | Al | SiO₂ |
| hematite | content | content | content |
| particles | (wt %) | (wt %) | (wt %) |
| Particles 6 | 1.58 | 0.06 | 0.02 |
| Particles 7 | 1.21 | 0.77 | 1.56 |
| Particles 8 | 1.17 | 2.70 | 0.03 |
| Particles 9 | 1.15 | 0.04 | 0.02 |
| Particles 10 | 0.63 | 1.17 | 0.01 |

| | Properties of non-magnetic particles for | | |
|---|---|---|---|
| | non-magnetic undercoat layer | | |
| | | | P content in |
| Kinds of | Y | Zn | P-containing |
| hematite | content | content | coating |
| particles | (wt %) | (wt %) | layer (wt %) |
| Particles 6 | 0.01 | 0.01 | 0.95 |
| Particles 7 | 0.01 | 0.01 | 1.20 |
| Particles 8 | 1.87 | 0.01 | 1.16 |
| Particles 9 | 0.01 | 0.01 | 0.59 |
| Particles 10 | 0.01 | 0.01 | — |

### Examples 1-2 to 1-4 and Comparative Examples 1-1 and 1-2

The same procedure as defined in Example 1-1 was conducted except that kinds of hematite particles used and kinds and amounts of surface-treating additives, were changed variously, thereby obtaining non-magnetic particles for non-magnetic undercoat layer.

Essential production conditions are shown in Table 6, and various properties of the obtained non-magnetic particles for non-magnetic undercoat layer are shown in Table 7.

### Example 1-5

Ten kilograms of the non-magnetic particles for non-magnetic undercoat layer produced in the same manner as defined in Example 1-1 were charged in to an edge runner and disaggregated while operating the edge runner. Then, 200 g of methyl triethoxysilane (tradename: “TSL8123”, produced by GE TOSHIBA SILICONE CO., LTD.) was added to the non-magnetic particles, and the resultant mixture was mixed and stirred at a linear load of 588 N/cm and a stirring speed of 22 rpm for 20 min.

Next, 2000 g of the highly-purified carbon black 1 was added to the hematite particles treated with methyl triethoxysilane over 10 min while operating the edge runner. Further, the mixed particles were continuously mixed and stirred at a linear load of 588 N/cm and a stirring speed of 22 rpm for 30 min to adhere the carbon black 1 on the coating layer comprising methyl triethoxysilane, and then heat-treated at 105° C. for 12 hr using a dryer, thereby obtaining composite non-magnetic particles for non-magnetic undercoat layer as particles of Example 1-5. As a result of observing the composite non-magnetic particles for non-magnetic undercoat layer as particles of Example 1-5 using an electron microscope, it was confirmed that since substantially no liberated carbon black particles were recognized, almost a whole amount of the carbon black added was adhered onto the coating layer of an organosilane compound produced from the methyl triethoxysilane.

Various properties of the obtained composite non-magnetic particles for non-magnetic undercoat layer as particles of Example 1-5 are shown in Table 7.

### Comparative Example 1-3

12 kg of the particles 1 as hematite particles were subjected to the same disaggregation and dispersion treatments as defined in Example 1-1, thereby obtaining a dispersed slurry containing the hematite particles.

After adjusting the concentration of the obtained dispersed slurry containing the hematite particles to 62 g/L, 180 L of the slurry was sampled. The thus sampled slurry was heated to 60° C. while stirring. Then, an aqueous aluminum sulfate solution and an aqueous zinc sulfate solution were gradually added to the slurry containing the hematite particles, and the resultant slurry was aged for 20 min. Next, the slurry was mixed with a 0.1N acetic acid solution to adjust the pH value of the slurry to 6.5. Thereafter, the slurry was filtered, washed with water and then dried by ordinary methods. 10 kg of the resultant dried particles were charged into an edge runner “MPUV-2 Model” (tradename) manufactured by Matsumoto Chuzo Tekkosho Co., Ltd., and mixed and stirred at 392 N/cm for 20 min to lightly disaggregate agglomerates of the particles, thereby obtaining hematite particles as particles of Comparative Example 1-3 whose surface was coated an oxide and/or a hydroxide of Al and Zn.

Various properties of the thus obtained hematite particles as particles of Comparative Example 1-3 are shown in Table 7.

The particles obtained in Comparative Example 1-2 comprised the hematite particles, the inner coating layer formed on the respective hematite particles which comprised the aluminum-containing inorganic compound, and the outer coating layer formed on the inner coating layer which comprised the phosphorus-containing inorganic compound. It was confirmed that the aluminum content in the inner coating layer comprising the aluminum-containing inorganic compound (in terms of Al) was 1.10% by weight, and the phosphorus content in the outer coating layer comprising the phosphorus-containing inorganic compound was 0.94% by weight.

The particles obtained in Comparative Example 1-3 comprised the hematite particles and the coating layer formed on the respective hematite particles which comprised the zinc/aluminum-containing inorganic compound. It was confirmed that the aluminum content in the coating layer (in terms of Al) was 0.95% by weight, and the zinc content in the coating layer (in terms of Zn) was 1.88% by weight.

TABLE 6

| | Surface treatment step | | | | | |
|---|---|---|---|---|---|---|
| Examples | Kind of | | | | Coating | |
| and | hematite | Additives | | | material | |
| Comp. | particles | | In terms | Amount | | Amount |
| Examples | used | Kind | of | (wt %) | Kind | (wt %) |
| Example | Particles | Sodium | Na₂Al₂O₄ | 3.3 | Al | 1.09 |
| 1-1 | 6 | aluminate | | | | |
| Example | Particles | Aluminum | Al₂(SO₄)₃ | 14.7 | Al | 2.28 |
| 1-2 | 7 | sulfate | | | | |
| Example | Particles | Sodium | Na₂Al₂O₄ | 3.2 | Al | 1.06 |
| 1-3 | 8 | aluminate | | | | |
| Example | Particles | Aluminum | Al₂(SO₄)₃ | 3.2 | Al | 0.71 |
| 1-4 | 9 | sulfate | | | | |
| Comp. | Particles | Sodium | Na₂Al₂O₄ | 3.3 | Al | 1.08 |
| Example | 1 | aluminate | | | | |
| 1-1 | | | | | | |
| Comp. | Particles | Phosphoric | H₃PO₄ | 3.0 | P | 0.94 |
| Example | 10 | acid | | | | |
| 1-2 | | | | | | |
| Comp. | Particles | Zinc | ZnSO₄ | 5.0 | Zn | 1.88 |
| Example | 1 | sulfate | | | | |
| 1-3 | | Aluminum | Al₂(SO₄)₃ | 7.0 | Al | 0.95 |
| | | sulfate | | | | |

TABLE 7

| | Properties of non-magnetic particles | | | |
|---|---|---|---|---|
| | for non-magnetic undercoat layer | | | |
| | Average | Average | | |
| | primary | primary | | BET |
| Examples | major axis | minor axis | Aspect | specific |
| and Comp. | diameter | diameter | ratio | surface |
| Examples | (μm) | (μm) | (—) | area (m²/g) |
| Example 1-1 | 0.094 | 0.0161 | 5.8 | 56.5 |
| Example 1-2 | 0.073 | 0.0112 | 6.5 | 76.9 |
| Example 1-3 | 0.043 | 0.0074 | 5.8 | 91.2 |
| Example 1-4 | 0.143 | 0.0210 | 6.8 | 50.1 |
| Example 1-5 | 0.096 | 0.0162 | 5.8 | 57.2 |
| Comp. | 0.094 | 0.0162 | 5.8 | 55.5 |
| Example 1-1 | | | | |
| Comp. | 0.095 | 0.0161 | 5.9 | 58.1 |
| Example 1-2 | | | | |
| Comp. | 0.095 | 0.0161 | 5.9 | 56.5 |
| Example 1-3 | | | | |

| | Properties of non-magnetic particles for | | |
|---|---|---|---|
| | non-magnetic undercoat layer | | |
| Examples | P | Al | SiO₂ |
| and Comp. | content | content | content |
| Examples | (wt %) | (wt %) | (wt %) |
| Example 1-1 | 1.59 | 1.15 | 0.02 |
| Example 1-2 | 1.22 | 3.05 | 1.55 |
| Example 1-3 | 1.15 | 3.76 | 0.04 |
| Example 1-4 | 1.16 | 0.76 | 0.02 |
| Example 1-5 | 1.51 | 1.11 | 0.29 |
| Comp. | 0.69 | 1.15 | 0.02 |
| Example 1-1 | | | |
| Comp. | 1.57 | 1.15 | 0.02 |
| Example 1-2 | | | |
| Comp. | 0.61 | 1.02 | 0.02 |
| Example 1-3 | | | |

| | Properties of non-magnetic particles for | | |
|---|---|---|---|
| | non-magnetic undercoat layer | | |
| | | | Al content in |
| Examples | Y | Zn | Al-containing |
| and Comp. | content | content | coating |
| Examples | (wt %) | (wt %) | layer (wt %) |
| Example 1-1 | 0.01 | 0.01 | 1.09 |
| Example 1-2 | 0.01 | 0.01 | 2.28 |
| Example 1-3 | 1.87 | 0.01 | 1.06 |
| Example 1-4 | 0.01 | 0.01 | 0.71 |
| Example 1-5 | 0.01 | 0.01 | 1.09 |
| Comp. | 0.01 | 0.01 | 1.08 |
| Example 1-1 | | | |
| Comp. | 0.01 | 0.01 | — |
| Example 1-2 | | | |
| Comp. | 0.01 | 1.89 | 0.95 |
| Example 1-3 | | | |

| | Properties of non-magnetic particles for | | |
|---|---|---|---|
| | non-magnetic undercoat layer | | |
| | Al/P | Adsorption of | |
| | ratio in | sodium | Elution |
| Examples | respective | dodecylbenzene | of iron |
| and Comp. | coating | sulfonate | ions |
| Examples | layers (—) | (mg/m²) | (ppm) |
| Example 1-1 | 1.15 | 1.27 | 2.8 |
| Example 1-2 | 1.90 | 1.21 | 2.5 |
| Example 1-3 | 0.91 | 1.13 | 4.0 |
| Example 1-4 | 1.20 | 1.17 | 2.4 |
| Example 1-5 | 1.15 | 1.10 | 1.2 |
| Comp. | — | 0.92 | 28.5 |
| Example 1-1 | | | |
| Comp. | 1.17 | 0.84 | 43.7 |
| Example 1-2 | | | |
| Comp. | — | 0.89 | 3.7 |
| Example 1-3 | | | |

### <Production of Non-Magnetic Undercoat Layer>

### Non-Magnetic Undercoat Layers 2 to 5 and Comparative None-Magnetic Undercoat Layers 1 to 6:

The same procedure for production of the non-magnetic undercoat layer 1 as defined above was conducted except that kinds of non-magnetic particles for non-magnetic undercoat layer were changed variously, thereby obtaining non-magnetic undercoat layers.

Essential production conditions as well as various properties of the thus obtained non-magnetic undercoat layers are shown in Table 8.

TABLE 8

| | Production of non-magnetic |
|---|---|
| Non-magnetic undercoat | undercoat layer |
| layers and comparative | Kind of non-magnetic |
| non-magnetic undercoat | particles for non-magnetic |
| layers | undercoat layer |
| Non-magnetic | Example 1-1 |
| undercoat layer 1 | |
| Non-magnetic | Example 1-2 |
| undercoat layer 2 | |
| Non-magnetic | Example 1-3 |
| undercoat layer 3 | |
| Non-magnetic | Example 1-4 |
| undercoat layer 4 | |
| Non-magnetic | Example 1-5 |
| undercoat layer 5 | |
| Comparative | Particles 1 |
| non-magnetic | |
| undercoat layer 1 | |
| Comparative | Particles 6 |
| non-magnetic | |
| undercoat layer 2 | |
| Comparative | Particles 5 |
| non-magnetic | |
| undercoat layer 3 | |
| Comparative | Comparative |
| non-magnetic | Example 1-1 |
| undercoat layer 4 | |
| Comparative | Comparative |
| non-magnetic | Example 1-2 |
| undercoat layer 5 | |
| Comparative | Comparative |
| non-magnetic | Example 1-3 |
| undercoat layer 6 | |

| | Properties of non-magnetic | | | |
|---|---|---|---|---|
| Non-magnetic | undercoat layer | | | |
| undercoat layers | | | | Young's |
| and comparative | | | Surface | modulus |
| non-magnetic | Thickness | Gloss | roughness | (relative |
| undercoat layers | (μm) | (%) | Ra (nm) | value) |
| Non-magnetic | 1.7 | 210 | 5.3 | 130 |
| undercoat layer 1 | | | | |
| Non-magnetic | 1.6 | 202 | 5.8 | 128 |
| undercoat layer 2 | | | | |
| Non-magnetic | 1.6 | 194 | 6.4 | 123 |
| undercoat layer 3 | | | | |
| Non-magnetic | 1.9 | 206 | 6.0 | 134 |
| undercoat layer 4 | | | | |
| Non-magnetic | 1.7 | 201 | 5.8 | 133 |
| undercoat layer 5 | | | | |
| Comparative | 1.7 | 157 | 15.2 | 114 |
| non-magnetic | | | | |
| undercoat layer 1 | | | | |
| Comparative | 1.8 | 162 | 14.0 | 117 |
| non-magnetic | | | | |
| undercoat layer 2 | | | | |
| Comparative | 1.8 | 158 | 14.7 | 125 |
| non-magnetic | | | | |
| undercoat layer 3 | | | | |
| Comparative | 1.7 | 163 | 12.2 | 121 |
| non-magnetic | | | | |
| undercoat layer 4 | | | | |
| Comparative | 1.8 | 172 | 11.5 | 122 |
| non-magnetic | | | | |
| undercoat layer 5 | | | | |
| Comparative | 1.7 | 171 | 11.7 | 129 |
| non-magnetic | | | | |
| undercoat layer 6 | | | | |

### Production of Magnetic Recording Medium

### Examples 2-2 to 2-5 and Comparative Examples 2-1 to 2-6

The same procedure as defined in Example 2-1 was conducted except that kinds of the non-magnetic undercoat layers and kinds of the magnetic particles were changed variously, thereby obtaining magnetic recording media.

Meanwhile, various properties of the magnetic particles (1) to (3) used above are shown in Table 9.

TABLE 9

| Magnetic | |
|---|---|
| particles | Kind of magnetic particles |
| Magnetic | Magnetic metal particles containing iron |
| particles (1) | as a main component |
| Magnetic | Magnetic metal particles containing iron |
| particles (2) | as a main component |
| Magnetic | Barium ferrite particles |
| particles (3) | (Ti/Fe = 1.5 mol %, Ni/Fe = 2.8 mol %) |

| | Properties of magnetic particles | | | |
|---|---|---|---|---|
| | | Average | Average | Aspect |
| | | primary | primary | ratio |
| | | major axis | minor axis | (plate |
| Magnetic | Particle | diameter | diameter | ratio) |
| particles | shape | (μm) | (μm) | (—) |
| Magnetic | Acicular | 0.063 | 0.0116 | 5.4 |
| particles (1) | | | | |
| Magnetic | Acicular | 0.038 | 0.0098 | 3.9 |
| particles (2) | | | | |
| Magnetic | Plate- | 0.032 | 0.0090 | 3.6 |
| particles (3) | shaped | | | |

| | Properties of magnetic particles | | | |
|---|---|---|---|---|
| | Coercive | | Saturation | |
| Magnetic | force | | magnetization | |
| particles | kA/m | Oe | Am²/kg | emu/g |
| Magnetic | 187.0 | 2,350 | 131.8 | 131.8 |
| particles (1) | | | | |
| Magnetic | 169.5 | 2,130 | 95.9 | 95.9 |
| particles (2) | | | | |
| Magnetic | 205.9 | 2,587 | 50.1 | 50.1 |
| particles (3) | | | | |

Essential production conditions as well as various properties of the obtained magnetic recording media are shown in Table 10.

TABLE 10

| | |
|---|---|
| Examples | Production of magnetic recording medium |

| and Comp. | Kind of non-magnetic | | Kind of magnetic | |
|---|---|---|---|---|
| Examples | undercoat layer | | particles | |
| Example 2-1 | Non-magnetic | | Magnetic | |
| | undercoat layer 1 | | particles (1) | |
| Example 2-2 | Non-magnetic | | Magnetic | |
| | undercoat layer 2 | | particles (2) | |
| Example 2-3 | Non-magnetic | | Magnetic | |
| | undercoat layer 3 | | particles (1) | |
| Example 2-4 | Non-magnetic | | Magnetic | |
| | undercoat layer 4 | | particles (3) | |
| Example 2-5 | Non-magnetic | | Magnetic | |
| | undercoat layer 5 | | particles (1) | |
| Comp. | Comparative | | Magnetic | |
| Example 2-1 | non-magnetic | | particles (1) | |
| | undercoat layer 1 | | | |
| Comp. | Comparative | | Magnetic | |
| Example 2-2 | non-magnetic | | particles (1) | |
| | undercoat layer 2 | | | |
| Comp. | Comparative | | Magnetic | |
| Example 2-3 | non-magnetic | | particles (1) | |
| | undercoat layer 3 | | | |
| Comp. | Comparative | | Magnetic | |
| Example 2-4 | non-magnetic | | particles (1) | |
| | undercoat layer 4 | | | |
| Comp. | Comparative | | Magnetic | |
| Example 2-5 | non-magnetic | | particles (1) | |
| | undercoat layer 5 | | | |
| Comp. | Comparative | | Magnetic | |
| Example 2-6 | non-magnetic | | particles (1) | |
| | undercoat layer 6 | | | |
| | Properties of magnetic recording medium | | | |
| | Thickness of | | | |
| Examples | magnetic | Coercive | | |
| and Comp. | recording | force | | Gloss |
| Examples | layer (μm) | kA/m | Oe | (%) |
| Example 2-1 | 0.27 | 194.2 | 2,440 | 222 |
| Example 2-2 | 0.28 | 175.1 | 2,200 | 216 |
| Example 2-3 | 0.27 | 192.6 | 2,420 | 198 |
| Example 2-4 | 0.28 | 209.3 | 2,630 | 212 |
| Example 2-5 | 0.27 | 191.0 | 2,400 | 210 |
| Comp. | 0.28 | 191.0 | 2,400 | 150 |
| Example 2-1 | | | | |
| Comp. | 0.28 | 189.4 | 2,380 | 159 |
| Example 2-2 | | | | |
| Comp. | 0.28 | 192.6 | 2,420 | 172 |
| Example 2-3 | | | | |
| Comp. | 0.27 | 191.8 | 2,410 | 176 |
| Example 2-4 | | | | |
| Comp. | 0.28 | 191.0 | 2,400 | 184 |
| Example 2-5 | | | | |
| Comp. | 0.27 | 189.4 | 2,380 | 180 |
| Example 2-6 | | | | |

| | Properties of magnetic recording medium | | |
|---|---|---|---|
| | | Young's | |
| Examples | Surface | modulus | Friction |
| and Comp. | roughness | (relative | coefficient |
| Examples | Ra (nm) | value) | (—) |
| Example 2-1 | 5.1 | 140 | 0.20 |
| Example 2-2 | 5.5 | 136 | 0.19 |
| Example 2-3 | 6.1 | 132 | 0.21 |
| Example 2-4 | 5.9 | 140 | 0.21 |
| Example 2-5 | 5.7 | 138 | 0.20 |
| Comp. | 14.8 | 121 | 0.44 |
| Example 2-1 | | | |
| Comp. | 13.0 | 129 | 0.42 |
| Example 2-2 | | | |
| Comp. | 13.9 | 134 | 0.38 |
| Example 2-3 | | | |
| Comp. | 12.7 | 135 | 0.35 |
| Example 2-4 | | | |
| Comp. | 11.1 | 133 | 0.32 |
| Example 2-5 | | | |
| Comp. | 11.2 | 137 | 0.31 |
| Example 2-6 | | | |

| | Properties of magnetic recording medium | | |
|---|---|---|---|
| | | Rate of increase | |
| | | in friction | Rate of increase |
| | D/O | coefficient | in D/O between |
| Examples | (number | between before | before and after |
| and Comp. | per | and after | preservation |
| Examples | msec) | preservation (%) | (number per msec) |
| Example 2-1 | 8 | 15 | 2 |
| Example 2-2 | 9 | 16 | 2 |
| Example 2-3 | 10 | 17 | 4 |
| Example 2-4 | 9 | 19 | 3 |
| Example 2-5 | 7 | 12 | 1 |
| Comp. | 34 | 45 | 34 |
| Example 2-1 | | | |
| Comp. | 31 | 40 | 29 |
| Example 2-2 | | | |
| Comp. | 30 | 41 | 27 |
| Example 2-3 | | | |
| Comp. | 29 | 37 | 23 |
| Example 2-4 | | | |
| Comp. | 27 | 33 | 17 |
| Example 2-5 | | | |
| Comp. | 25 | 29 | 14 |
| Example 2-6 | | | |

The non-magnetic particles for non-magnetic undercoat layer of magnetic recording medium according to the present invention are excellent in affinity to binder resins containing a metal sulfonate group, and can be prevented from suffering from elution of iron ions therefrom, and are therefore suitable as non-magnetic particles for non-magnetic undercoat layer of magnetic recording medium.

The magnetic recording medium of the present invention exhibits a good surface smoothness as a tape and a good storage property, and is therefore suitable as a high-density magnetic recording medium.

1.-8. (canceled)

9. A process for producing non-magnetic particles for non-magnetic undercoat layer of magnetic recording medium, comprising:
hematite particles;
an inner coating layer comprising a phosphorus-containing inorganic compound which is formed on a surface of the respective hematite particles; and
an outer coating layer comprising an aluminum-containing inorganic compound which is formed on an outside of the inner coating layer comprising the phosphorus-containing inorganic compound,
which process comprises:
subjecting goethite particles as a starting material to heat treating to obtain hematite particles,
coating the hematite particles with the phosphorus-containing inorganic compound to form an inner coating layer and
coating the surface of the inner coating layer with the aluminum-containing inorganic compound to form an outer coating layer.

10. A process according to claim 9, wherein the step of subjecting goethite particles as a starting material to heat-treating comprises:
first subjecting the goethite particles as a starting material to low temperature heat dehydration in a temperature range of 250 to 500° C. to thereby obtain low-density hematite particles, and thereafter
heat-treating the thus obtained low-density hematite particles in a high temperature range of 500 to 850° C.

11. A process according to claim 9, wherein a content of P in the inner coating layer comprising the phosphorus-containing inorganic compound is 0.1 to 5% by weight, and a content of Al in the outer coating layer comprising the aluminum-containing inorganic compound is 0.1 to 8% by weight.

12. A process according to claim 9, further comprising a compound containing at least one rare earth element, in an amount of 0.1 to 20% by weight in terms of the rare earth element.

13. A process according to claim 9, wherein the amount of iron ions eluted from the non-magnetic particles is not more than 5.0 ppm in terms of Fe.

14. A process according to claim 9, wherein the amount of iron ions eluted from the non-magnetic particles is not more than 4.5 ppm in terms of Fe.

15. A process according to claim 9, wherein the amount of iron ions eluted from the non-magnetic particles is not more than 4.0 ppm in terms of Fe.

16. A process for producing composite non-magnetic particles for non-magnetic undercoat layer of magnetic recording medium, which composite non-magnetic particles comprise the non-magnetic particles for non-magnetic undercoat layer as defined in claim 9, a coating layer comprising a surface-modifying agent which is formed on a surface of the respective non-magnetic particles, and carbon black adhered onto the coating layer,
which process comprises
obtaining the non-magnetic particles for non-magnetic undercoat layer by the method as defined in claim 9,
mixing the non-magnetic particles for non-magnetic undercoat layer with a surface-modifying agent to coat the surface of the respective non-magnetic particles for non-magnetic undercoat layer with the surface-modifying agent, and
mixing the non-magnetic particles for non-magnetic undercoat layer which are coated with the surface-modifying agent, with carbon black.

17. A process for producing a magnetic recording medium comprising a non-magnetic substrate; a non-magnetic undercoat layer formed on the non-magnetic substrate which comprises the non-magnetic particles for non-magnetic undercoat layer of magnetic recording medium as defined in claim 9, and a binder resin; and a magnetic recording layer formed on the non-magnetic undercoat layer which comprises magnetic particles and a binder resin,
which process comprises
obtaining the non-magnetic particles for non-magnetic undercoat layer by the method as defined in claim 9,
preparing respective coating materials for the non-magnetic undercoat layer using the obtained non-magnetic particles for non-magnetic undercoat layer and magnetic recording layer, and
successively applying on one surface of the non-magnetic substrate in the order of the non-magnetic undercoat layer and magnetic recording layer with the thus prepared coating materials for the non-magnetic undercoat layer and magnetic recording layer.

18. A process for producing a magnetic recording medium comprising a non-magnetic substrate; a non-magnetic undercoat layer formed on the non-magnetic substrate which comprises the composite non-magnetic particles for non-magnetic undercoat layer of magnetic recording medium as defined in claim 16, and a binder resin; and a magnetic recording layer formed on the non-magnetic undercoat layer which comprises magnetic particles and a binder resin,
which process comprises
obtaining the composite non-magnetic particles for non-magnetic undercoat layer by the method as defined in claim 16,
preparing respective coating materials for the non-magnetic undercoat layer using the obtained non-magnetic particles for non-magnetic undercoat layer and magnetic recording layer, and
successively applying on one surface of the non-magnetic substrate in the order of the non-magnetic undercoat layer and magnetic recording layer with the thus prepared coating materials for the non-magnetic undercoat layer and magnetic recording layer.

19. A process for producing a magnetic recording medium comprising a non-magnetic substrate; a non-magnetic undercoat layer formed on one surface of the non-magnetic substrate which comprises the non-magnetic particles for non-magnetic undercoat layer of magnetic recording medium as defined in claim 9, and a binder resin; a magnetic recording layer formed on the non-magnetic undercoat layer which comprises magnetic particles and a binder resin; and a back coat layer formed on the opposite surface of the non-magnetic substrate,
which process comprises
obtaining the non-magnetic particles for non-magnetic undercoat layer by the method as defined in claim 9,
preparing respective coating materials for the non-magnetic undercoat layer using the obtained non-magnetic particles for non-magnetic undercoat layer, magnetic recording layer and back coat layer,
successively applying on one surface of the non-magnetic substrate in the order of the non-magnetic undercoat layer and magnetic recording layer with the thus prepared coating materials for the non-magnetic undercoat layer and magnetic recording layer, and
applying with the coating material for the back coat layer onto the surface of the non-magnetic substrate which is opposed to the surface where the non-magnetic undercoat layer and magnetic recording layer are formed.
